(19) United States
(12) Patent Application Publication
(10) Pub. No.: US 2024/0283863 A1
(43) Pub. Date: Aug. 22, 2024

(54) METHOD FOR ADJUSTING VOLUME OF AUDIO SIGNAL OUTPUT FROM ELECTRONIC DEVICE, AND DEVICE THEREFOR

(71) Applicant: Samsung Electronics Co., Ltd., Suwon-si (KR)

(72) Inventors: Euijun KIM, Suwon-si (KR); Dahye SHIM, Suwon-si (KR); Donghun SHIN, Suwon-si (KR)

(73) Assignee: Samsung Electronics Co., Ltd., Suwon-si (KR)

(21) Appl. No.: 18/651,254

(22) Filed: Apr. 30, 2024

Related U.S. Application Data
(63) Continuation of application No. PCT/KR2022/014231, filed on Sep. 23, 2022.

(30) Foreign Application Priority Data
Nov. 25, 2021 (KR) 10-2021-0164862

(51) Int. Cl. H04M 1/7243; H04M 1/72415; H04R 1/02

(52) U.S. Cl. CPC H04M 1/7243; H04M 1/72415; H04R 1/028; H04R 2430/01; H04R 2499/15

(57) ABSTRACT

A method of adjusting a volume of an audio signal output from an electronic device. In particular, the method of adjusting a volume of an audio signal output from an electronic device includes: obtaining, from an external source, information related to adjustment of the volume of the audio signal which is output from the electronic device; determining, based on the obtained information, whether to adjust the volume of the audio signal output from the electronic device; and adjusting, based on the determining, the volume of the audio signal output from the electronic device.

### CROSS-REFERENCE TO RELATED APPLICATION

This application is a continuation application, under 35 U.S.C. § 111(a), of international application No. PCT/KR2022/014231, filed on Sep. 23, 2022, which claims priority under 35 U. S. C. § 119 to Korean Patent Application No. 10-2021-0164862, filed on Nov. 25, 2021, in the Korean Intellectual Property Office, the disclosures of which are incorporated by reference herein in their entireties.

### TECHNICAL FIELD

Embodiments of the present disclosure relate to a method of adjusting a volume of an audio signal output from an electronic device, and a device therefor.

### BACKGROUND ART

When a user watches content via an electronic device, various situations in which other content is also viewed via other electronic device, an important message is received via a portable terminal or the like may occur.

For example, when other content is also viewed via other electronic device, an audio signal output from the electronic device may overlap. For example, when the content is viewed via the electronic device, a message may be received via the electronic device.

According to the various situations, the user needs to appropriately adjust a volume of the content being output via the electronic device.

### DISCLOSURE

### Technical Solution

According to an embodiment of the present disclosure, a method of adjusting a volume of an audio signal may include obtaining, from an external source, information related to adjustment of the volume of the audio signal which is output from an electronic device. According to an embodiment of the present disclosure, the method may include determining, based on the obtained information, whether to adjust the volume of the audio signal output from the electronic device. According to an embodiment of the present disclosure, the method may include adjusting the volume of the audio signal output from the electronic device, based on determining whether to adjust the volume of the audio signal output from the electronic device.

According to an embodiment of the present disclosure, an electronic device that may include an audio output configured to output an audio signal, a memory to store one or more instructions, and at least one processor configured to execute the one or more instructions. According to an embodiment of the present disclosure, the at least one processor may be configured to obtain, from an external source, information related to adjustment of a volume of the audio signal output from the audio output unit. According to an embodiment of the present disclosure, the at least one processor may be configured to determine, based on the obtained information, whether to adjust the volume of the audio signal output from the audio output. According to an embodiment of the present disclosure, the at least one processor may be configured to adjust the volume of the audio signal output from the audio output, based on determining whether to adjust the volume of the audio signal output from the audio output. According to an embodiment of the present disclosure, a recording medium may include a non-transitory computer-readable recording medium having recorded thereon a program executable on a computer to perform the method disclosed herein.

### DESCRIPTION OF DRAWINGS

FIG. 1 is a diagram illustrating a method of adjusting a volume of an audio signal output from an electronic device, according to an embodiment of the present disclosure.

FIG. 2 is a block diagram for describing an electronic device configured to adjust a volume of an audio signal, according to an embodiment of the present disclosure.

FIG. 3 is a block diagram for describing an electronic device configured to adjust a volume of an audio signal, according to an embodiment of the present disclosure.

FIG. 4 is a flowchart for adjusting a volume of an audio signal output from an electronic device, according to an embodiment of the present disclosure.

FIG. 5 is a flowchart for adjusting a volume of an audio signal output from an electronic device, based on information about an audio signal output from an external electronic device, according to an embodiment of the present disclosure.

FIG. 6 is a flowchart for adjusting a volume of an audio signal output from an electronic device, based information about an audio signal output from an electronic device, according to an embodiment of the present disclosure.

FIG. 7 is a flowchart for describing a method of obtaining information about an audio signal output from an external electronic device, according to an embodiment of the present disclosure.

FIG. 8 is a diagram for describing a method of determining whether a sensed audio signal is a signal output from an external electronic device, based on amplitude of each frequency band of a received audio signal, according to an embodiment of the present disclosure.

FIG. 9 is a diagram for describing a method of adjusting a volume of an audio signal output from an electronic device, based on information about an input of a user, according to an embodiment of the present disclosure.

FIG. 10 is a diagram for describing a method of adjusting a volume of a system sound signal, based on a content sound signal, according to an embodiment of the present disclosure.

FIG. 11 is a diagram for describing a method of adjusting a volume of a system sound signal, based on a content sound signal, according to an embodiment of the present disclosure.

FIG. 12 is a diagram for describing a method of decreasing a volume of a system sound signal when an input of a user is input by a preset second threshold or more for a preset first time, according to an embodiment of the present disclosure.

FIG. 13 is a flowchart for adjusting a volume of a content sound signal, based on event occurrence information related to occurrence of an event, according to an embodiment of the present disclosure.

FIG. 14 is a flowchart for describing a method of adjusting a volume of a content sound signal, based on event occurrence information related to occurrence of an event and event end information related to an end of the event, according to an embodiment of the present disclosure.

FIG. 15 is a diagram for describing a method of adjusting a volume of a content sound signal, based on event occurrence information related to occurrence of an event and event end information related to an end of the event, according to an embodiment of the present disclosure.

FIG. 16 is a diagram for describing a method of adjusting a volume of a content sound signal, based on event occurrence information related to occurrence of an event and event end information related to an end of the event, according to an embodiment of the present disclosure.

FIG. 17 is a diagram for describing a method of providing a user interface (UI) related to volume adjustment of an audio signal via a display unit of an electronic device, according to adjustment of a volume of the audio signal, according to an embodiment of the present disclosure.

### MODE FOR INVENTION

Terms that are used in the present disclosure will be briefly described, and an embodiment of the present disclosure will be described in detail.

All terms used in the present disclosure are general terms that are selected in consideration of their functions in the present disclosure and are currently widely used. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description of the present disclosure. Therefore, the terms used in the present disclosure are not merely designations of the terms, but the terms are defined based on the meaning of the terms and content throughout the present disclosure.

Throughout the specification, when a part “includes” or “comprises” an element, unless there is a particular description contrary thereto, the part may further include other elements, not excluding the other elements. Also, the term “unit”, as used in the specification, means a software or hardware element, such as a Field Programmable Gate Array (FPGA) or Application Specific Integrated Circuit (ASIC), which performs certain tasks. However, the term “unit” does not mean to be limited to software or hardware. A unit may be configured to be in an addressable storage medium or configured to operate one or more processors. Thus, a unit may include, by way of example, elements, such as software elements, object-oriented software elements, class elements, and task elements, processes, functions, attributes, procedures, subroutines, segments of program code, drivers, firmware, microcode, circuitry, data, databases, data structures, tables, arrays, and variables. The functionality provided in the elements and “units” may be combined into fewer elements and “units” or further separated into additional elements and “units”.

Hereinafter, the present disclosure will now be described more fully with reference to the accompanying drawings for one of ordinary skill in the art to be able to perform the embodiments of the present disclosure without any difficulty. An embodiment of the present disclosure may be embodied in many different forms and should not be construed as being limited to the embodiments set forth herein. In addition, portions irrelevant to the description will be omitted in the drawings for a clear description of an embodiment of the present disclosure, and like reference numerals will denote like elements throughout the present disclosure.

Throughout the specification, it will be understood that when an element is referred to as being “connected to” or “coupled with” another element, it can be directly connected to or coupled with the other element, or it can be electrically connected to or coupled with the other element by having an intervening element interposed therebetween. Also, when a part “includes” or “comprises” an element, unless there is a particular description contrary thereto, the part can further include other elements, not excluding the other elements.

Throughout the present disclosure, the expression “at least one of a, b or c” indicates only a, only b, only c, both a and b, both a and c, both b and c, all of a, b, and c, or variations thereof.

Throughout the present disclosure, while terms “first” and “second” are used to describe various elements (or a plurality of pieces of information), it is obvious that the elements are not limited to the terms “first” and “second”. The terms are used only to distinguish between each of elements (or a plurality of pieces of information). For example, without departing from the scope of the present disclosure, a first element (or information) may be referred to as a second element (or information), and similarly, a second element (or information) may be referred to as a first element (or information). The term “and/or” includes any and all combinations of one or more of the associated listed items.

An embodiment of the present disclosure may provide a method of adjusting a volume of an audio signal output form an electronic device and a device therefor, when information related to adjustment of the volume of the audio signal output from the electronic device is obtained from an external source.

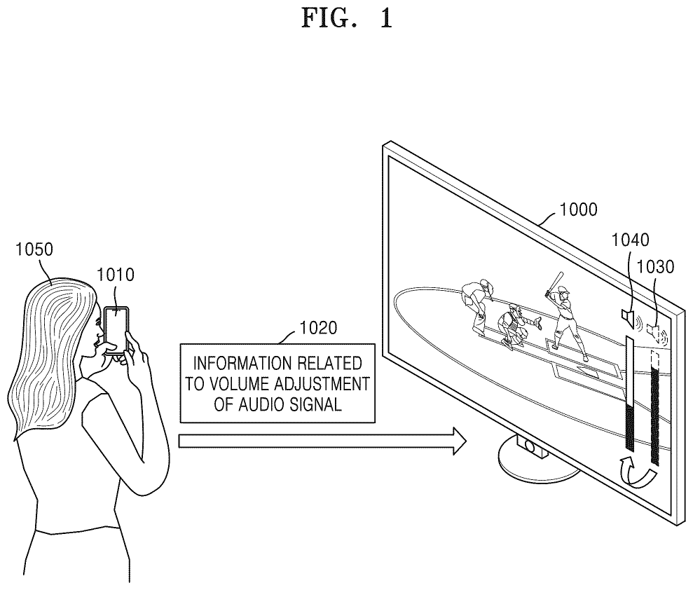

FIG. 1 is a diagram illustrating a method of adjusting a volume of an audio signal output from an electronic device 1000, according to an embodiment of the present disclosure.

FIG. 1 illustrates a user 1050, and the electronic device 1000 configured to adjust a volume of an audio signal. The electronic device 1000 may adaptively adjust an audio signal output from the electronic device 1000, based on information related to volume adjustment of the audio signal output from the electronic device 1000.

According to an embodiment of the present disclosure, the user 1050 may watch a movie via an external electronic device 1010 while the user 1050 watches a drama via the electronic device 1000. As an audio signal of the drama output via the electronic device 1000 and an audio signal of the movie output via the external electronic device 1010 overlap, it may be difficult for the user 1050 to appropriately watch the movie output via the external electronic device 1010.

According to an embodiment of the present disclosure, the electronic device 1000 may obtain information 1020 related to volume adjustment of an audio signal, thereby determining whether to adjust a volume of the audio signal output from the electronic device 1000. For example, when the user 1050 increases a volume of the external electronic device 1010 and then obtains information indicating watching of the movie, the electronic device 1000 may determine to decrease a volume of the drama output from the electronic device 1000. On the other hand, when the electronic device 1000 obtains information indicating that the user 1050 decreases a volume of the external electronic device 1010, the electronic device 1000 may determine to increase the volume of the drama output from the electronic device 1000, but the present disclosure is not limited thereto.

According to an embodiment of the present disclosure, information related to volume adjustment of an audio signal may include at least one of information about an audio signal output from the external electronic device 1010, information about an input of the user 1050, and event occurrence information related to occurrence of an event, but the present disclosure is not limited thereto.

According to an embodiment of the present disclosure, based on a result of determining whether to adjust the volume of the audio signal, the electronic device 1000 may adjust the volume of the audio signal output from the electronic device 1000. For example, when the user 1050 increases the volume of the movie and watches the movie via the external electronic device 1010, the electronic device 1000 may automatically change a volume level of the drama from a first level 1030 to a second level 1040. Here, the second level 1040 may indicate a level lower than the first level 1030. Therefore, the user 1050 may conveniently watch the movie via the external electronic device 1010 without manually adjusting a volume of the electronic device 1000.

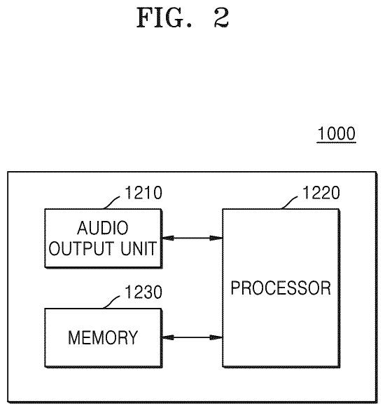

FIG. 2 is a block diagram for describing an electronic device configured to adjust a volume of an audio signal, according to an embodiment of the present disclosure.

According to an embodiment of the present disclosure, the electronic device 1000 may be the electronic device configured to adjust a volume of an audio signal, and more particularly, may be the electronic device configured to adjust a volume of an output audio signal, based on information related to volume adjustment of the audio signal, the information being obtained from an external source.

According to an embodiment of the present disclosure, the electronic device 1000 may include an audio output unit 1210, a processor 1220, and a memory 1230. Hereinafter, the elements will now be sequentially described.

The audio output unit 1210 may be an output unit configured of at least one speaker. According to some embodiments of the present disclosure, based on the information related to volume adjustment of the audio signal, which is obtained from the external source, the processor 1220 may determine whether to adjust a volume of an audio signal output from the electronic device 1000. Based on the determining, the processor 1220 may control an operation of adjusting a volume of an audio signal output from the audio output unit 1210.

Also, according to an embodiment of the present disclosure, the audio signal output from the audio output unit 1210 may include at least one of a content sound signal related to content that the user 1050 watches via the electronic device 1000, system sound corresponding to an input of the user 1050, and an event sound signal related to occurrence of an event, but the present disclosure is not limited thereto.

The processor 1220 may control all operations of the electronic device 1000, and may control an operation of the electronic device 1000 by executing one or more instructions stored in the memory 1230.

According to an embodiment of the present disclosure, the processor 1220 may be configured to execute the one or more instructions stored in the memory 1230 to obtain, from an external source, information related to volume adjustment of an audio signal output from the audio output unit 1210. The processor 1220 may determine, based on the obtained information, whether to adjust a volume of the audio signal output from the audio output unit 1210. Based on the determining, the processor 1220 may adjust the volume of the audio signal output from the audio output unit 1210.

According to an embodiment of the present disclosure, the obtained information may be information about an audio signal output from the external electronic device 1010. The processor 1220 may be configured to execute the one or more instructions stored in the memory 1230 to adjust the volume of the audio signal output from the audio output unit 1210 when a volume of the audio signal output from the external electronic device 1010 is changed from a first level to a second level by a preset first threshold or more.

According to an embodiment of the present disclosure, the processor 1220 may be configured to execute the one or more instructions stored in the memory 1230 to determine whether a sensed audio signal is an audio signal output from the external electronic device 1010, based on amplitude of each frequency band of the audio signal output from the external electronic device 1010.

According to an embodiment of the present disclosure, the obtained information may include information about a user input. According to an embodiment of the present disclosure, an audio signal may include a content sound signal output from the audio output unit 1210 and a system sound signal output from the audio output unit 1210. According to an embodiment of the present disclosure, the processor 1220 may be configured to execute the one or more instructions stored in the memory 1230 to determine to adjust a volume of the system sound signal, based on the content sound signal, as information about an input of the user 1050 is obtained.

According to an embodiment of the present disclosure, the processor 1220 may be configured to execute the one or more instructions stored in the memory 1230 to decrease a volume of the system sound signal, when an input of the user 1050 which indicates a preset second threshold or more is input for a preset first time.

According to an embodiment of the present disclosure, the obtained information may include event occurrence information related to occurrence of an event. According to an embodiment of the present disclosure, an audio signal may include a content sound signal output from the electronic device 1000 and an event sound signal output from the electronic device 1000. The processor 1220 may be configured to execute the one or more instructions stored in the memory 1230 to determine whether to adjust a volume of the content sound signal, based on whether the event is included in a preset event.

The memory 1230 may store a program for processing and controlling by the processor 1220. According to an embodiment of the present disclosure, the memory 1230 may store one or more instructions.

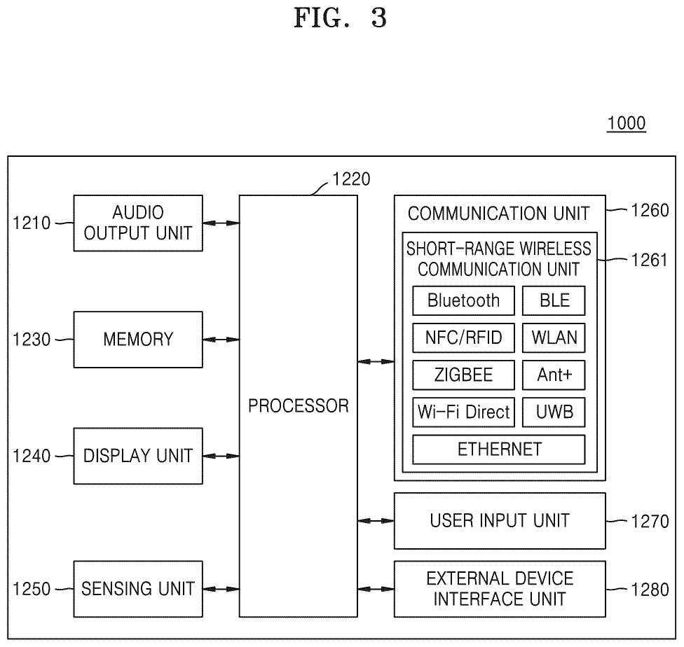

Not all elements shown in FIG. 2 are necessary elements of the electronic device 1000. The electronic device 1000 may be embodied with more elements than the shown elements or may be embodied with fewer elements than the shown elements. For example, as shown in FIG. 3, the electronic device 1000 according to an embodiment of the present disclosure may include the audio output unit 1210, the processor 1220, the memory 1230, a display unit 1240, a sensing unit 1250, a communication unit 1260, a user input unit 1270, and an external device interface unit 1280.

FIG. 3 is a block diagram for describing the electronic device 1000 configured to adjust a volume of an audio signal, according to an embodiment of the present disclosure.

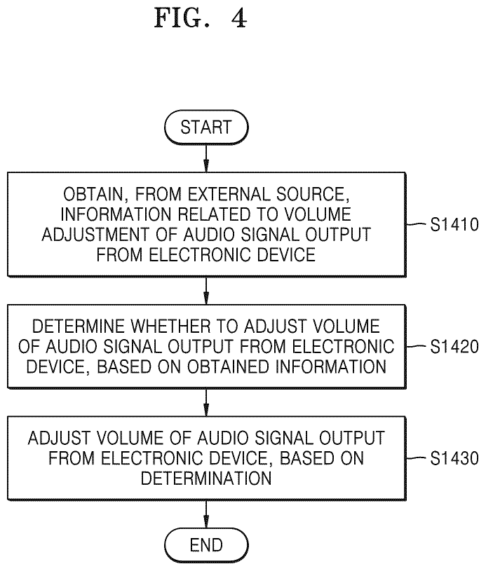

According to an embodiment of the present disclosure, the electronic device 1000 may be the electronic device configured to adjust a volume of an audio signal. The electronic device 1000 may include various types of a device a user can use, the device including a mobile phone, a tablet person computer (PC), a personal digital assistant (PDA), a MPEG-1 audio layer-3 (MP3) player, a kiosk, an electronic photoframe, a navigation device, a digital television (TV), or a wearable device such as a wrist watch, a head-mounted display (HMD), or the like. The electronic device 1000 may correspond to the electronic device 1000 to be shown in FIGS. 4 to 17 below, but the present disclosure is not limited thereto.

Also, the electronic device 1000 may further include the display unit 1240, the sensing unit 1250, the communication unit 1260, the user input unit 1270, the external device interface unit 1280, and a power supply unit (not shown), in addition to the audio output unit 1210, the processor 1220, and the memory 1230. Hereinafter, the elements shown in FIG. 3 will now be sequentially described.

The audio output unit 1210 may be an output unit configured of at least one speaker. According to an embodiment of the present disclosure, based on the information related to volume adjustment of the audio signal, which is obtained from the external source, the processor 1220 may determine whether to adjust a volume of an audio signal output from the electronic device 1000. Based on a result of determining whether to adjust the volume of the output audio signal, the processor 1220 according to an embodiment of the present disclosure may control an operation of adjusting a volume of an audio signal output from the audio output unit 1210.

According to an embodiment of the present disclosure, the processor 1220 may control all operations of the electronic device 1000. According to an embodiment of the present disclosure, the processor 1220 may be configured to execute the one or more instructions stored in the memory 1230 to control an operation of the electronic device 1000. For example, the processor 1220 may be configured to execute one or more programs stored in the memory 1210 to overall control the audio output unit 1210, the memory 1230, the display unit 1240, the sensing unit 1250, the communication unit 1260, the user input unit 1270, the external device interface unit 1280, the power supply unit (not shown), or the like.

The processor 1220 may include at least one of a random access memory (RAM), a read-only memory (ROM), a central processing unit (CPU), a graphics processing unit (GPU), and a bus. The RAM, the ROM, the CPU, the GPU, or the like may be connected to each other via the bus. According to an embodiment of the present disclosure, the processor 1220 may include an artificial intelligence (AI) processor configured to generate a learning network model, but the present disclosure is not limited thereto. According to an embodiment of the present disclosure, the AI processor may be implemented as a chip separate from the processor 1220. According to an embodiment of the present disclosure, the AI processor may be a general-purpose chip.

According to an embodiment of the present disclosure, the processor 1220 may be configured to execute the one or more instructions stored in the memory 1230 to obtain, from an external source, information related to volume adjustment of an audio signal output from the audio output unit 1210. According to an embodiment of the present disclosure, the processor 1220 may determine, based on the obtained information, whether to adjust a volume of the audio signal output from the audio output unit 1210. According to an embodiment of the present disclosure, based on a result of determining whether to adjust the volume of the output audio signal, the processor 1220 may adjust the volume of the audio signal output from the audio output unit 1210.

The memory 1230 may store a program for processing and controlling by the processor 1220. According to an embodiment of the present disclosure, the memory 1230 may store the one or more instructions, and may include at least one of an internal memory (not shown) and an external memory (not shown). The memory 1230 may store various programs and data used in an operation of the electronic device 1000. For example, the memory 1230 may store an AI model configured to obtain information related to volume adjustment of an audio signal output from the electronic device 1000. The AI model may use, as training data, at least one information among an audio signal output from the external electronic device 1010 and event occurrence information related to occurrence of an event. For example, the memory 1230 may store an AI model trained on a doorbell sound as training data. When the electronic device 1000 detects doorbell sound via the sensing unit 1250, the electronic device 1000 may determine that event information indicating that the user 1050 arrives at home is obtained.

The internal memory may include, for example, at least one of a volatile memory (e.g., a dynamic RAM (DRAM), a static RAM (SRAM), a synchronous dynamic RAM (SDRAM), etc.), a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, etc.), a hard disk drive (HDD) or a solid-state drive (SSD).

According to an embodiment of the present disclosure, the processor 1220 may load, to a volatile memory, and process a command or data received from at least one of a non-volatile memory or other element. Also, the processor 1220 may store, in the non-volatile memory, data received from or generated by other element.

The external memory may include, for example, at least one of a compact flash (CF), a secure digital (SD), a micro secure digital (micro-SD), a mini secure digital (mini-SD), an extreme digital (xD) and a memory stick.

The display unit 1240 may include a display panel and a controller (not shown) configured to control the display panel. The display panel may be implemented as a display in various forms including a liquid crystal display (LCD), an organic light emitting diode (OLED) display, active-matrix organic light-emitting diode (AM-OLED), a plasma display panel (PDP), or the like. The display panel may be implemented to be flexible, transparent, or wearable. The display unit 1240 may be combined with a touch panel of the user input unit 1270 so as to be provided as a touch screen (not shown). For example, the touch screen (not shown) may include an integrated module that combines the display panel and the touch panel in a laminated structure.

The sensing unit 1250 may include a temperature sensor, a camera sensor, a voice sensor, a gyro sensor, and a global positioning system (GPS) sensor, but the present disclosure is not limited thereto. According to an embodiment of the present disclosure, the electronic device 1000 may sense, via the sensing unit 1250, information related to volume adjustment of an output audio signal.

According to an embodiment of the present disclosure, the electronic device 1000 may sense an audio signal output from the external electronic device 1010, via the voice sensor. According to an embodiment of the present disclosure, the processor 1220 may determine, based on amplitude of each frequency band of a received audio signal, whether the audio signal sensed via the sensing unit 1250 is an audio signal output from the external electronic device 1010 or is information related to utterance of the user 1050, but the present disclosure is not limited thereto. In order to sense an audio signal, the sensing unit 1250 may include the voice sensor.

According to an embodiment of the present disclosure, the electronic device 1000 may sense event occurrence information related to occurrence of an event, via the temperature sensor or the camera sensor included in the sensing unit 1250. For example, the temperature sensor included in the sensing unit 1250 may sense whether there is fire, based on a temperature around the electronic device 1000. Also, for example, the camera sensor included in the sensing unit 1250 may sense occurrence of an event such as a person entering through a door near the electronic device 1000, but the present disclosure is not limited thereto.

The communication unit 1260 may include one or more elements configured to perform communication between the electronic device 1000 and a plurality of devices located around the electronic device 1000. The communication unit 1260 may include one or more elements configured to allow communication between the electronic device 1000 and a server or a cloud. In more detail, the communication unit 1260 may perform communication with various types of an external device or server, according to various types of a communication scheme. Also, the communication unit 1260 may include a short-range wireless communication unit 1261.

The short-range wireless communication unit 1261 may include a Bluetooth communication unit, a Bluetooth low energy (BLE) communication unit, a near field communication unit, a WLAN (Wi-Fi) communication unit, a Zigbee communication unit, an infrared Data Association (IrDA) communication unit, a Wi-Fi direct (WFD) communication unit, a ultra wideband (UWB) communication unit, an Ant+ communication unit, an Ethernet communication unit, or the like, but the present disclosure is not limited thereto.

According to an embodiment of the present disclosure, the electronic device 1000 may obtain information related to volume adjustment of an audio signal, via the communication unit 1260 from the external electronic device 1010 that shares the same network. For example, the external electronic device 1010 may be at least one of a mobile terminal and a cloud, but the present disclosure is not limited thereto.

The user input unit 1270 may receive various commands from the user 1050. The user input unit 1270 may include at least one of a key, a touch panel, and a pen-recognition panel. The electronic device 1000 may display various pieces of content or a user interface, in response to a user input received from at least one of the key, the touch panel, and the pen-recognition panel. The key may include various types of a key including a mechanical button, a wheel, or the like arranged on various areas such as a front surface, a side surface, a rear surface, etc. of a main body exterior of the electronic device 1000. The touch panel may sense a touch input of the user 1050, and may output a touch event value corresponding to a signal generated by the sensed touch input. When the touch panel is combined with the display panel and thus is formed as the touch screen (not shown), the touch screen may be formed of a touch sensor with various types including a capacitive type, a resistive type, a piezoelectric type, or the like. According to an embodiment of the present disclosure, a threshold related to a similarity between a voice signal and at least one preset trigger word may be adjusted via the user input unit 1270, but the present disclosure is not limited thereto.

According to an embodiment of the present disclosure, the electronic device 1000 may obtain information about an input of the user 1050 via the user input unit 1270. Also, based on a content sound signal output from the audio output unit 1210 as the electronic device 1000 obtains the information about the input of the user 1050, the electronic device 1000 may appropriately adjust a volume of a system sound signal corresponding to the input of the user 1050. Also, the communication unit 1260 of the electronic device 1000 may receive a signal with respect to an input of the user 1050 which is received via a user input unit of the external electronic device 1010, but the present disclosure is not limited thereto.

The external device interface unit 1280 provides an interface environment between the electronic device 1000 and various external devices. The external device interface unit 1280 may include an audio/video (A/V) input and output unit. The external device interface unit 1280 may connected to, by wire or wirelessly, an external device including a digital versatile disk (DVD) and Blu-ray, a game device, a camera, a computer, an air-conditioner, a notebook, a desktop, a television, or a digital display device, etc. or the external electronic device 1010. The external device interface unit 1280 may transmit an image, a video, and a voice signal, which are input via a connected external device, to the processor 1220 of the electronic device 1000. The processor 1220 may control a data signal such as a processed image, video, voice, or the like to be output to the connected external device or the external electronic device 1010. The A/V input and output unit may include a universal serial bus (USB) terminal, a composite video banking sync (CVBS) terminal, a component terminal, a S-video terminal (analog), a digital visual interface (DVI) terminal, a high definition multimedia interface (HDMI) terminal, a RGB terminal, a D-SUB terminal, etc. so as to input an image and voice signal of an external device or the external electronic device 1010 to the electronic device 1000. According to an embodiment of the present disclosure, the processor 1220 may be connected to the external device or the external electronic device 1010, which outputs an audio signal, via an interface such as an HDMI terminal of the external device interface unit 1280, but the present disclosure is not limited thereto. Here, the processor 1220 may obtain information about an audio signal output from the external electronic device 1010 or the external device.

The electronic device 1000 may further include the power supply unit (not shown). The power supply unit (not shown) may supply power to elements of the electronic device 1000, based on control by the processor 1220. The power supply unit (not shown) may supply power to each of the elements of the electronic device 1000, the power being input from an external power source via a power code, based on control by the processor 1220.

FIG. 4 is a flowchart for adjusting a volume of an audio signal output from the electronic device 1000, according to an embodiment of the present disclosure.

In operation S1410, the electronic device 1000 according to an embodiment may obtain, from an external source, information related to volume adjustment of an audio signal output from the electronic device 1000.

According to an embodiment of the present disclosure, the electronic device 1000 may obtain an audio signal, an input of the user 1050, or event occurrence information related to occurrence of an event from the external electronic device 1010 or an external device, in order to appropriately adjust an audio signal output from the audio output unit 1210.

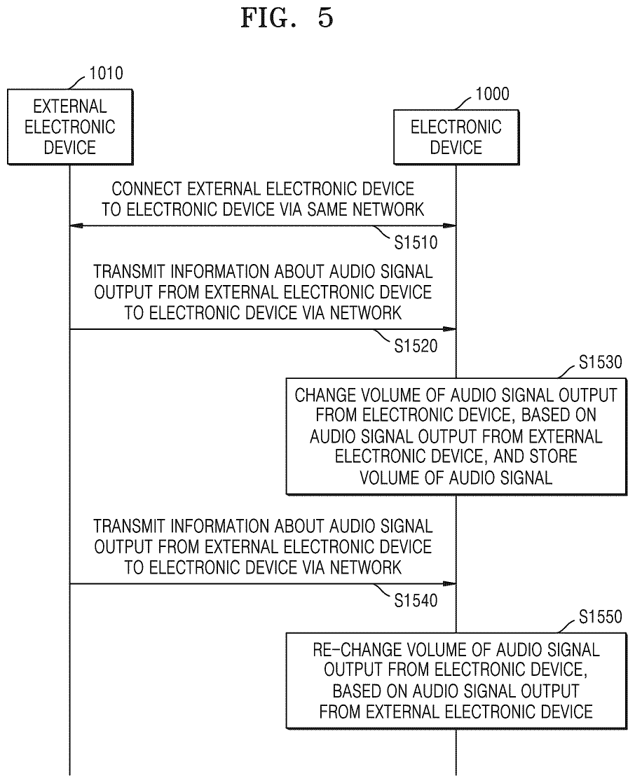

According to an embodiment of the present disclosure, the electronic device 1000 may receive, via the communication unit 1260, information about an audio signal output from the external electronic device 1010 or the external device. Also, the electronic device 1000 may directly sense, via the sensing unit 1250, the information about the audio signal output from the external electronic device 1010 or the external device. For example, the audio signal output from the external electronic device 1010 or the external device may have large amplitude of a high frequency band, compared to an audio signal due to utterance of the user 1050. Therefore, the electronic device 1000 may determine whether a sensed audio signal is the audio signal output from the external electronic device 1010 or the external device or the audio signal due to utterance of the user 1050, based on amplitude of each frequency band of the sensed audio signal, but the present disclosure is not limited thereto. An operation of adjusting a volume of an audio signal output from the electronic device 1000, based on the audio signal output from the external electronic device 1010 or the external device, will be described in detail with reference to FIGS. 5 to 8.

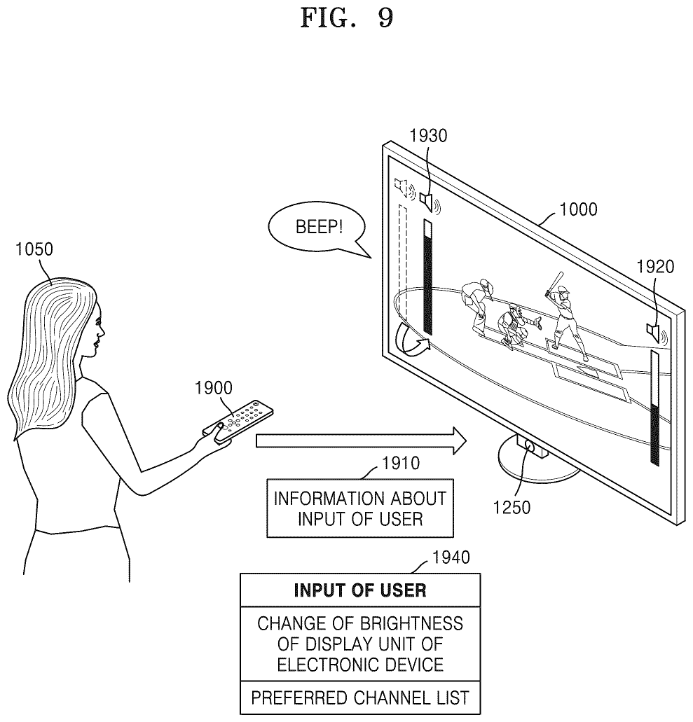

According to an embodiment of the present disclosure, the electronic device 1000 may obtain information about an input of the user 1050. For example, the electronic device 1000 may obtain the information about the input of the user 1050 via a user input unit of the external electronic device 1010 or the external device. Also, for example, the electronic device 1000 may obtain the information about the input of the user 1050 via the user input unit 1270. According to an embodiment of the present disclosure, the input of the user 1050 may include at least one of an input related to adjustment of brightness of the display unit 1240 of the electronic device 1000 and an input related to channel search, but the present disclosure is not limited thereto. An operation of adjusting a volume of an audio signal output from the electronic device 1000, based on the information about the input of the user 1050, will be described in detail with reference to FIGS. 9 to 12.

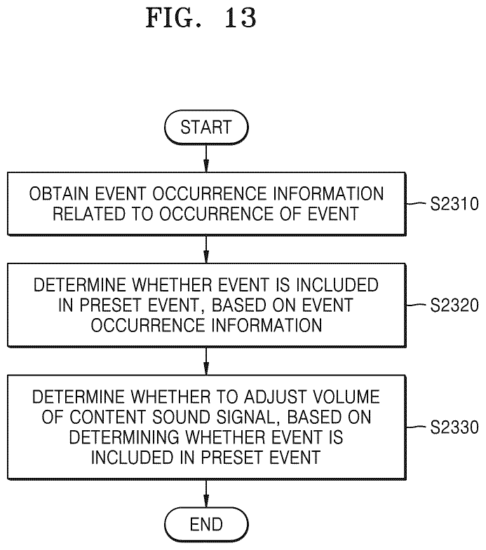

According to an embodiment of the present disclosure, the electronic device 1000 may obtain event occurrence information related to occurrence of an event. The electronic device 1000 may obtain the event occurrence information related to occurrence of the event from the external electronic device 1010 or the external device which is connected to the external device interface unit 1280 of the electronic device 1000 via the communication unit 1260. For example, the electronic device 1000 may obtain, via the communication unit 1260, notification information indicating that an important message is received from a mobile terminal connected to the electronic device 1000. Also, the electronic device 1000 may obtain the event occurrence information related to occurrence of the event by sensing occurrence of the event via the sensing unit 1250, but the present disclosure is not limited thereto. An operation in which the electronic device 1000 adjusts a volume of an audio signal output from the electronic device 1000, based on the event occurrence information related to occurrence of the event, will be described in detail with reference to FIGS. 13 to 16.

In operation S1420, the electronic device 1000 according to an embodiment of the present disclosure may determine whether to adjust the volume of the audio signal output from the electronic device 1000, based on the obtained information.

According to an embodiment of the present disclosure, in order to provide information necessary for the user 1050 or to prevent overlapping of audio signals, the electronic device 1000 may determine whether to adjust the volume of the audio signal output from the electronic device 1000.

According to an embodiment of the present disclosure, the electronic device 100 may adjust the volume of the audio signal output from the electronic device 1000, based on information about an audio signal output from the external electronic device 1010 or the external device. For example, when a volume of the audio signal output from the external electronic device 1010 or the external device is increased, the electronic device 1000 may determine that the user 1050 listens to the audio signal via the external electronic device 1010 or the external device, and thus, may decrease the volume of the audio signal output from the audio output unit 1210 of the electronic device 1000.

According to an embodiment of the present disclosure, the electronic device 1000 may adjust the volume of the audio signal output from the electronic device 1000, based on the information about the input of the user 1050. When the information about the input of the user 1050 is information related to brightness of the display unit 1240 of the electronic device 1000, the electronic device 1000 may adjust a system sound signal due to the input of the user 1050, in consideration of the volume of the audio signal (here, the audio signal may indicate a content sound signal) output from the audio output unit 1210. For example, when the user 1050 watches content with a low sound level via the electronic device 1000, in order not to disturb immersion of the user 1050, the electronic device 1000 may adjust and output a system sound signal with a low sound level, the system sound signal corresponding to the input of the user 1050, but the present disclosure is not limited thereto.

According to an embodiment of the present disclosure, the electronic device 1000 may adjust the volume of the audio signal output from the electronic device 1000, based on the event occurrence information related to occurrence of the event. For example, an event such as an important message, a phone call, a doorbell, or the like may be stored in the memory 1230 of the electronic device 1000. According to an embodiment of the present disclosure, the electronic device 1000 may adjust the volume of the audio signal output from the electronic device 1000, based on whether an event is included in a preset event. For example, the electronic device 1000 may receive, from a mobile terminal, information indicating an incoming call from an important client, and the incoming call from the important client may be included in the preset event. Here, the electronic device 1000 may decrease a volume of a content sound signal output via the audio output unit 1210, and may provide an event sound signal related to the incoming call from the important client to a user, but the present disclosure is not limited thereto.

In operation S1430, the electronic device 1000 according to an embodiment of the present disclosure may adjust the volume of the audio signal output from the electronic device 1000, based on the determination.

The electronic device 1000 according to an embodiment of the present disclosure may determine and adjust a volume of an audio signal which is appropriate for the user 1050, in overall consideration of the information related to volume adjustment of the audio signal, a volume level of a currently-output audio signal, or the like. Also, when the electronic device 1000 receives event end information indicating an end of an event, the electronic device 1000 may re-change the volume of the audio signal output from the audio output unit 1210. Therefore, the electronic device 1000 may store the volume level of the currently-output audio signal, but the present disclosure is not limited thereto.

FIG. 5 is a flowchart for adjusting a volume of an audio signal output from the electronic device 1000, based on information about an audio signal output from the external electronic device 1010, according to an embodiment of the present disclosure. The external electronic device 1010 shown in FIG. 5 is not limited to the external electronic device 1010 shown in FIG. 1 The external electronic device 1010 shown in FIG. 5 may be referred to as an external device.

In operation S1510, the electronic device 1000 according to an embodiment of the present disclosure may be connected to the external electronic device 1010 via a same network.

According to an embodiment of the present disclosure, the electronic device 1000 may be connected to the external electronic device 1010 by wire or wirelessly via the external device interface unit 1280 or the communication unit 1260.

In operation S1520, the electronic device 1000 according to an embodiment of the present disclosure may receive information about an audio signal output from the external electronic device 1010, via the network from the external electronic device 1010. The information about the audio signal which is received in operation S1520 may include information related to volume adjustment of an audio signal output from the electronic device 1000. The receiving of the information about the audio signal output from the external electronic device 1010 via the network may include receiving of the information from the external electronic device 1010 via the communication unit 1260 included in the electronic device 1010 or receiving of transmission from the external electronic device 1010 via the external device interface unit 1280 included in the electronic device 1010, but the present disclosure is not limited thereto. For example, the electronic device 1000 may sense the audio signal output from the external electronic device 1010 via the sensing unit 1250.

For example, the electronic device 1000 may receive in real time or periodically the information about the audio signal output from the external electronic device 1010, via the network from the external electronic device 1010. The information about the audio signal output from the external electronic device 1010 may be information including at least one of content of the audio signal, a volume level of the audio signal, and a type of the external electronic device 1010 outputting the audio signal, but the present disclosure is not limited thereto.

In operation S1520, the electronic device 1000 according to an embodiment of the present disclosure may sense, from the external electronic device 1010, information indicating that the volume level of the audio signal output from the external electronic device 1010 is changed from a first level to a second level. In operation S1520, the electronic device 1000 may receive, from the external electronic device 1010, the information indicating that the volume level of the audio signal output from the external electronic device 1010 is changed from the first level to the second level, but the present disclosure is not limited thereto.

In operation S1530, the electronic device 1000 according to an embodiment of the present disclosure may change a volume of an audio signal output from the electronic device 1000, based on the audio signal output from the external electronic device 1010, and may store the volume of the audio signal. The storing of the volume of the audio signal may indicate storing of information indicating the volume of the audio signal.

For example, when the audio signal output from the external electronic device 1010 is changed by a preset first threshold or more, the electronic device 1000 according to an embodiment of the present disclosure may change a volume of the audio signal output from the electronic device 1000. For example, when the audio signal output from the external electronic device 1010 is increased by the preset first threshold or more, the electronic device 1000 according to an embodiment of the present disclosure may decrease the volume of the audio signal output from the electronic device 1000. For example, when the audio signal output from the external electronic device 1010 is decreased by the preset first threshold or more, the electronic device 1000 according to an embodiment of the present disclosure may increase the volume of the audio signal output from the electronic device 1000. For example, when the audio signal output from the external electronic device 1010 is changed by the preset first threshold or more as a volume level of the audio signal output from the external electronic device 1010 is changed from the first level to the second level, the electronic device 1000 according to an embodiment of the present disclosure may change the volume of the audio signal output from the electronic device 1000.

For example, when the volume level of the audio signal output from the external electronic device 1010 is the second level, the electronic device 1000 may adjust a volume of an audio signal output from the audio output unit 1210 so as not to disturb the user 1050 from listening to the audio signal output from the external electronic device 1010. For example, the electronic device 1000 may adjust the volume of the audio signal output from the audio output unit 1210 so as to be different from the volume level of the audio signal output from the external electronic device 1010 by 20 dB or more, but the present disclosure is not limited thereto. According to an embodiment of the present disclosure, the electronic device 1000 may preset a level of adjusting a volume of an audio signal output from the audio output unit 1210, based on a user input signal received via the user input unit 1270.

As the user 1050 stops watching content via the external electronic device 1010, the electronic device 1000 according to an embodiment of the present disclosure may re-change a volume level of the audio signal output from the electronic device 1000. For example, the electronic device 1000 may re-change a volume level of the audio signal output from the audio output unit 1210 to an original volume level. According to an embodiment of the present disclosure, before the electronic device 1000 changes the volume of the audio signal, the electronic device 1000 may store the volume level of the audio signal output from the audio output unit 1210 in the memory 1230. The storing of the volume level of the audio signal in the memory 1230 may indicate storing of volume level information of the audio signal in the memory 1230.

In operation S1540, the electronic device 1000 according to an embodiment of the present disclosure may receive information about an audio signal output from the external electronic device 1010, via the network from the external electronic device 1010. The receiving of the information about the audio signal output from the external electronic device 1010 via the network may include receiving of the information from the external electronic device 1010 via the communication unit 1260 included in the electronic device 1010 or receiving of transmission from the external electronic device 1010 via the external device interface unit 1280 included in the electronic device 1010, but the present disclosure is not limited thereto. For example, the electronic device 1000 may sense the audio signal output from the external electronic device 1010 via the sensing unit 1250.

According to an embodiment of the present disclosure, the electronic device 1000 may receive in real time or periodically the information about the audio signal output from the external electronic device 1010, via the network from the external electronic device 1010. In operation S1540, the electronic device 1000 according to an embodiment of the present disclosure may sense information indicating that the volume level of the audio signal output from the external electronic device 1010 is re-changed from a second level to a first level. Accordingly, the processor 1220 of the electronic device 1000 may determine to adjust a volume level of an audio signal output from the electronic device 1000 to its original volume level, based on the volume level of the audio signal output from the external electronic device 1010 being changed to its original level.

In operation S1550, the electronic device 1000 according to an embodiment of the present disclosure may re-change a volume of the audio signal output from the electronic device 1000, based on the audio signal output from the external electronic device 1010.

For example, the electronic device 1000 according to an embodiment of the present disclosure may change the volume level of the audio signal output from the electronic device 1000 to its original level stored in the memory 1230, based on the audio signal output from the external electronic device 1500.

For example, the electronic device 1000 may re-change the volume of the audio signal output from the electronic device 1000, in consideration of the volume level of the audio signal output from the external electronic device 1010. For example, the electronic device 1000 may re-change the volume of the audio signal output from the electronic device 1000 so as to allow the user 1050 to well listen to the audio signal output via the audio output unit 1210. For example, the electronic device 1000 may re-change the volume level of the audio signal output to be different, by 20 dB or more, from a first level that is the volume of the audio signal output from the external electronic device 1010, but the present disclosure is not limited thereto. The electronic device 1000 may preset, in the memory 1230, information about a level of re-changing a volume level of the audio signal, in order for the user 1050 to well listen to the audio signal output via the audio output unit 1210.

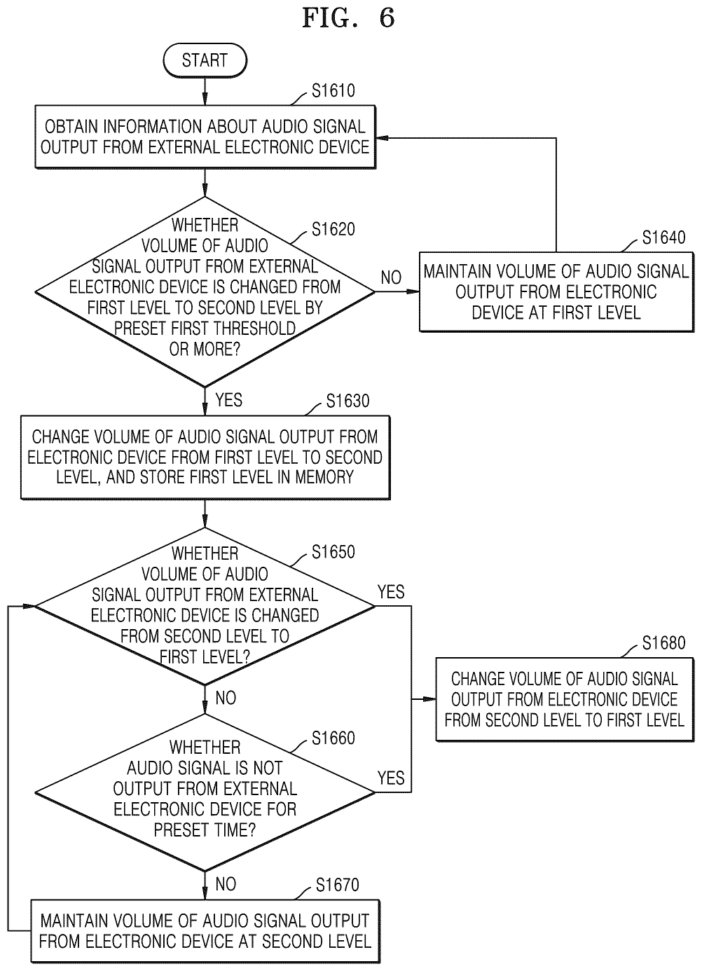

FIG. 6 is a flowchart for adjusting a volume of an audio signal output from the electronic device 1000, based information about an audio signal output from the external electronic device 1010, according to an embodiment of the present disclosure.

In operation S1610, the electronic device 1000 according to an embodiment of the present disclosure may obtain information about an audio signal output from the external electronic device 1010.

According to an embodiment of the present disclosure, the electronic device 1000 may obtain the information about the audio signal output from the external electronic device 1010, via the communication unit 1260, the external device interface unit 1280, or the sensing unit 1250. For example, the electronic device 1000 may obtain information about a volume or information about a volume level of the audio signal output from the external electronic device 1010.

In operation S1620, the electronic device 1000 according to an embodiment of the present disclosure may determine whether a volume (or a volume level) of the audio signal output from the external electronic device 1010 is changed from a first level to a second level by a preset first threshold or more.

The volume level of the audio signal output from the external electronic device 1010 may be changed from the first level to the second level. According to an embodiment of the present disclosure, the first level may be an initial volume level of a volume of the audio signal output from the external electronic device 1010. Also, when the user 1050 watches content via the external electronic device 1010 or stops watching content, the volume level of the audio signal output from the external electronic device 1010 may be changed to the second level. For example, when the user 1050 watches content via the external electronic device 1010, the second level may be greater than the first level. For example, when the user 1050 stops watching content via the external electronic device 1010, the second level may be smaller than the first level, but the present disclosure is not limited thereto.

According to an embodiment of the present disclosure, according to whether the volume of the audio signal output from the external electronic device 1010 is changed from the first level to the second level by a preset threshold or more, the electronic device 1000 may determine whether to adjust the volume level of the audio signal output from the audio output unit 1210.

In operation S1630, according to an embodiment of the present disclosure, when the volume of the audio signal output from the external electronic device 1010 is changed from the first level to the second level, and the changed volume level is equal to or greater than the preset first threshold, the electronic device 1000 may change a volume of the audio signal output from the electronic device 1000 from a first level to a second level, and may store the first level in the memory 1230.

According to an embodiment of the present disclosure, when the volume of the audio signal output from the external electronic device 1010 is changed from the first level to the second level, and the changed volume level is equal to or greater than a preset threshold, the electronic device 1000 may determine that there is a change in a situation in which the user 1050 watches content via the external electronic device 1010.

For example, when the volume level of the audio signal (in this case, the audio signal may be a content sound signal related to the content) output from the external electronic device 1010 is increased by the preset threshold or more, the electronic device 1000 may determine that the user 1050 watches the content via the external electronic device 1010. The electronic device 1000 may change the volume (or the volume level) of the audio signal output from the electronic device 1000 from a first level to a second level. Here, a volume of the second level may indicate a volume lower than a volume of the first level, but the present disclosure is not limited thereto.

Also, for example, when the volume level of the audio signal (in this case, the audio signal may be a content sound signal related to the content) output from the external electronic device 1010 is decreased by the preset threshold or more, the electronic device 1000 may determine that the user 1050 stops watching the content via the external electronic device 1010. The electronic device 1000 may change the volume (or the volume level) of the audio signal output from the electronic device 1000 from a first level to a second level. Here, a volume of the second level may indicate a volume greater than a volume of the first level, but the present disclosure is not limited thereto.

According to an embodiment of the present disclosure, the electronic device 1000 may change a volume of an audio signal output from the electronic device 1000 from a first level to a second level and may store the first level in the memory 1230. Afterward, when the volume level of the audio signal output from the external electronic device 1010 is re-changed to the first level that is an original volume level, the electronic device 1000 may re-change a volume level of the audio signal output from the electronic device 1000 from the second level to the first level stored in the memory 1230, but the present disclosure is not limited thereto.

In operation S1640, according to an embodiment of the present disclosure, when the volume of the audio signal output from the external electronic device 1010 is changed from the first level to the second level, and the changed volume level is not equal to or greater than the preset first threshold, the electronic device 1000 may maintain the volume (or the volume level) of the audio signal output from the electronic device 1000 at the first level.

According to an embodiment of the present disclosure, when the volume of the audio signal output from the external electronic device 1010 is changed from the first level to the second level, and the changed volume level is not equal to or greater than the preset first threshold, the electronic device 1000 may determine that there is no change in the situation in which the user 1050 watches the content via the external electronic device 1010. Therefore, the electronic device 1000 may maintain the volume of the audio signal output from the electronic device 1000 to be the first level, without a separate change.

In operation S1650, according to whether the volume of the audio signal output from the external electronic device 1010 is changed from the second level to the first level, the electronic device 1000 according to an embodiment of the present disclosure may adjust the volume of the audio signal output from the electronic device 1000.

In operation S1650, when the electronic device 1000 according to an embodiment of the present disclosure determines that the volume of the audio signal output from the external electronic device 1010 is changed from the second level to the first level, in operation S1680, the electronic device 1000 may re-change the volume of the audio signal output from the electronic device 1000 from the second level to the first level stored in the memory 1230.

For example, in operation S1630, when the volume level of the audio signal output from the external electronic device 1010 is increased, the electronic device 1000 may decrease the volume level of the audio signal output from the electronic device 1000. Here, when the volume level of the audio signal output from the external electronic device 1010 is decreased again, the electronic device 1000 may increase the volume level of the audio signal output from the electronic device 1000 from the second level to the first level stored in the memory 1230.

Also, for example, in operation S1630, when the volume level of the audio signal output from the external electronic device 1010 is decreased, the electronic device 1000 may increase the volume level of the audio signal output from the electronic device 1000. Here, when the volume level of the audio signal output from the external electronic device 1010 is increased again, the electronic device 1000 may decrease the volume level of the audio signal output from the electronic device 1000 from the second level to the first level stored in the memory 1230, but the present disclosure is not limited thereto.

According to an embodiment of the present disclosure, when the volume (or the volume level) of the audio signal output from the external electronic device 1010 is not changed from the second level to the first level, in operation S1660, the electronic device 1000 may determine whether the audio signal is not output from the external electronic device 1010 for a preset time.

After the external electronic device 1010 provides content to the user 1050, the external electronic device 1010 may mute the audio signal output from the external electronic device 1010, according to a request of the user 1050. When the audio signal output from the external electronic device 1010 is muted, the electronic device 1000 may determine whether the audio signal is not output from the external electronic device 1010 for a preset time, but the present disclosure is not limited thereto. When the electronic device 1000 determines that the audio signal is not output from the external electronic device 1010 for a preset time, the electronic device 1000 may determine that the user 1050 no longer watches content via the external electronic device 1010.

In operation S1660, when the audio signal is not output from the external electronic device 1010 for a preset time, the electronic device 1000 according to an embodiment of the present disclosure may determine that the user 1050 no longer watches content via the external electronic device 1010. Therefore, in operation S1680, the electronic device 1000 may re-change the volume of the audio signal output from the electronic device 1000 from the second level to the first level stored in the memory 1230.

In operation S1660, when the electronic device 1000 according to an embodiment of the present disclosure determines that the audio signal is output from the external electronic device 1010 for a preset time, in operation S1670, the electronic device 1000 may maintain the volume of the audio signal output from the electronic device 1000 at the second level.

According to an embodiment of the present disclosure, when the electronic device 1000 determines that the audio signal is output from the external electronic device 1010 for a preset time, the electronic device 1000 may determine that there is no change in a situation in which the user 1050 watches content via the external electronic device 1010. Therefore, the electronic device 1000 may maintain the volume level of the audio signal output from the electronic device 1000 to be the second level, without a separate change, but the present disclosure is not limited thereto.

In operation S1680, the electronic device 1000 according to an embodiment of the present disclosure may change the volume (or the volume level) of the audio signal output from the electronic device 1000 from the second level to the first level.

According to an embodiment of the present disclosure, the electronic device 1000 may re-change the volume of the audio signal output from the electronic device 1000 from the second level to the first level, based on whether the volume (or the volume level) of the audio signal output from the external electronic device 1010 is changed from the second level to the first level (operation S1650) or whether the audio signal is not output from the external electronic device 1010 for a preset time (operation S1660), but the present disclosure is not limited thereto. For example, the electronic device 1000 may re-change the volume of the audio signal output from the electronic device 1000 from the second level to the first level, according to an input of the user 1050. Also, after the electronic device 1000 changes the volume of the audio signal from the first level to the second level and then a preset time elapses, the electronic device 1000 may change the volume of the audio signal output from the electronic device 1000 from the second level to the first level.

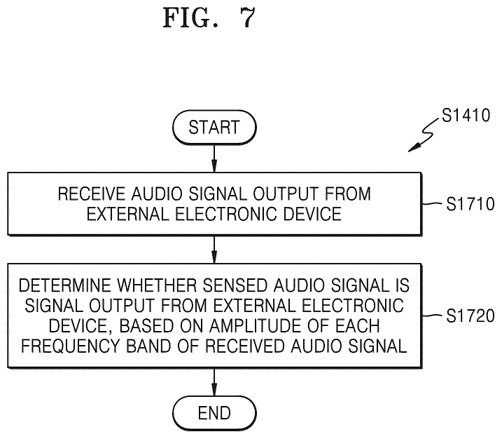

FIG. 7 is a flowchart for describing a method of obtaining information about an audio signal output from the external electronic device 1010, according to an embodiment of the present disclosure.

In operation S1710, the electronic device 1000 according to an embodiment of the present disclosure may receive an audio signal output from the external electronic device 1010.

According to an embodiment of the present disclosure, the electronic device 1000 may sense, via the sensing unit 1250, the audio signal output from the external electronic device 1010. Also, the electronic device 1000 may receive the audio signal output from the external electronic device 1010 via the communication unit 1250 or the external device interface unit 1280, but the present disclosure is not limited thereto.

In operation S1720, the electronic device 1000 according to an embodiment of the present disclosure may determine whether the sensed audio signal is a signal output from the external electronic device 1010, based on amplitude of each frequency band of the received audio signal.

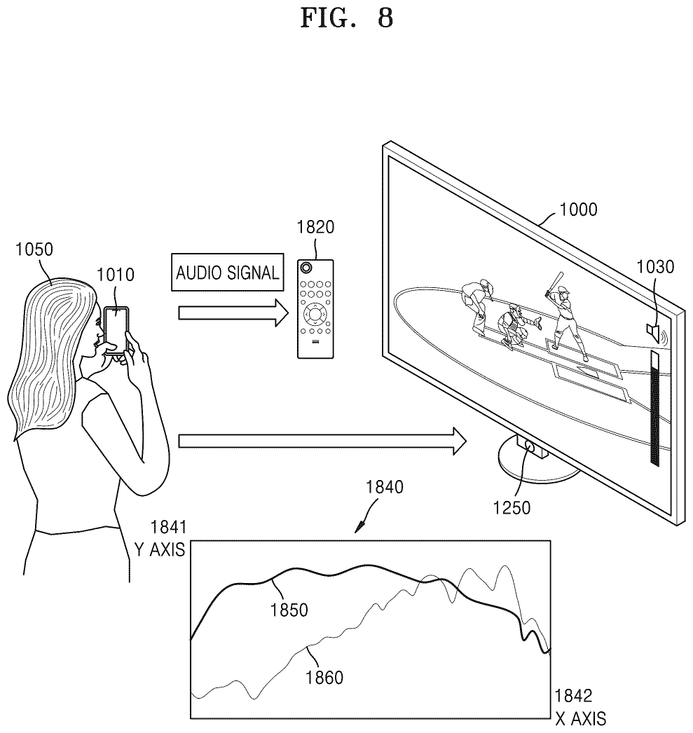

An audio signal output from the external electronic device 1010 according to an embodiment of the present disclosure and an audio signal uttered by a user may differ in amplitude of each frequency band. For example, the audio signal output from the external electronic device 1010 may have relatively large amplitude of a high frequency band, compared to an audio signal uttered by the user 1050. Therefore, based on amplitude of each frequency band of the sensed audio signal, the electronic device 1000 may determine whether the sensed audio signal is an audio signal output from the external electronic device 1010 or the audio signal uttered by the user 1050. An operation of determining whether the sensed audio signal is a signal output from the external electronic device 1010, based on amplitude of each frequency band of the received audio signal, will be described in detail with reference to FIG. 8.

FIG. 8 is a diagram for describing a method of determining whether a sensed audio signal is an audio signal output from the external electronic device 1010, based on amplitude of each frequency band of a received audio signal, according to an embodiment of the present disclosure.

According to an embodiment of the present disclosure, the user 1050 may watch a movie via the electronic device 1000 and may simultaneously watch a drama via the external electronic device 1010. The electronic device 1000 may receive an audio signal output from the external electronic device 1010. The external electronic device 1010 may be an electronic device including a mobile terminal, but the present disclosure is not limited thereto.

According to an embodiment of the present disclosure, the electronic device 1000 may receive information about the audio signal output from the external electronic device 1010 via an application associated between the external electronic device 1010 and the electronic device 1000. Also, the electronic device 1000 may sense the audio signal output from the external electronic device 1010 via the sensing unit 1250 arranged at the lower part of the electronic device 1000.

A voice receiver (not shown) of an external controller 1820 according to an embodiment of the present disclosure may receive the audio signal output from the external electronic device 1010. Also, the electronic device 1000 may receive, via the communication unit 1260, the audio signal received by the voice receiver of the external controller 1820, but the present disclosure is not limited thereto. For example, the electronic device 1000 may receive, via the external device interface unit 1280, the audio signal received by the voice receiver of the external controller 1820.

According to an embodiment of the present disclosure, the electronic device 1000 may determine whether the sensed audio signal is a signal output from the external electronic device 1010, based on amplitude of each frequency band of the received audio signal.

According to an embodiment of the present disclosure, the graph 1840 may indicate amplitude of each frequency band of a voice signal. The X-axis 1842 of the graph 1840 may indicate a frequency, and the Y-axis 1841 of the graph 1840 may indicate amplitude.

According to an embodiment of the present disclosure, amplitude of each frequency band 1860 of the audio signal output from the external electronic device 1010 may indicate to be large in a middle-frequency or high-frequency band. Also, amplitude of each frequency band 1850 of the audio signal due to utterance by the user 1050 may indicate to be large in a low-frequency band. Therefore, the electronic device 1000 according to an embodiment of the present disclosure may determine whether the sensed audio signal is an audio signal output from the external electronic device 1010 or utterance by the user 1050, based on amplitude of each frequency band of the received audio signal.

According to an embodiment of the present disclosure, the memory 1230 of the electronic device 1000 may store an AI model configured to determine whether the sensed audio signal is a signal output from the external electronic device 1010, based on amplitude of each frequency band of the received audio signal. The AI model configured to determine whether the sensed audio signal is a signal output from the external electronic device 1010 may use, as training data, an audio signal received by the electronic device 1000, but the present disclosure is not limited thereto.

FIG. 9 is a diagram for describing a method of adjusting a volume of an audio signal output from the electronic device 1000, based on information about an input of the user 1050, according to an embodiment of the present disclosure.

According to an embodiment of the present disclosure, the electronic device 1000 may adjust a volume of an audio signal output from the electronic device 1000, based on information about an input of the user 1050.

According to an embodiment of the present disclosure, the user 1050 may input a user input via the user input unit 1270 of the electronic device 1000 or a user input unit of an external controller 1900. The external controller 1900 may be an external controller configured to control the electronic device 1000, but the present disclosure is not limited thereto. For example, when the external controller 1900 is a mobile terminal, the user 1050 may input an input of the user 1050 via an application for controlling the electronic device 1000, the application being installed (or registered) in the external controller 1900.

According to an embodiment of the present disclosure, an input 1940 of the user 1050 may be an input of the user 1050 which is related to control of a system of the electronic device 1000. For example, the input 1940 of the user 1050 may be an input including at least one of changing of brightness of a display unit 1940 of the electronic device 1000 or browsing a preferred channel list, but the present disclosure is not limited thereto. For example, an input of the user 1050 may be an input for controlling setting information of the electronic device 1000 by pressing, by the user 1050, a setting button of the external controller 1900.

According to an embodiment of the present disclosure, the electronic device 1000 may adjust a volume level of the audio signal output from the electronic device 1000, based on information 1910 about an input of the user 1050. Here, the audio signal for which the electronic device 1000 adjusts the volume level may be a system sound signal 1930 corresponding to the input of the user 1050. For example, when there is the input of the user 1050, the system sound signal 1930 may be output as “beep!”, but the present disclosure is not limited thereto.

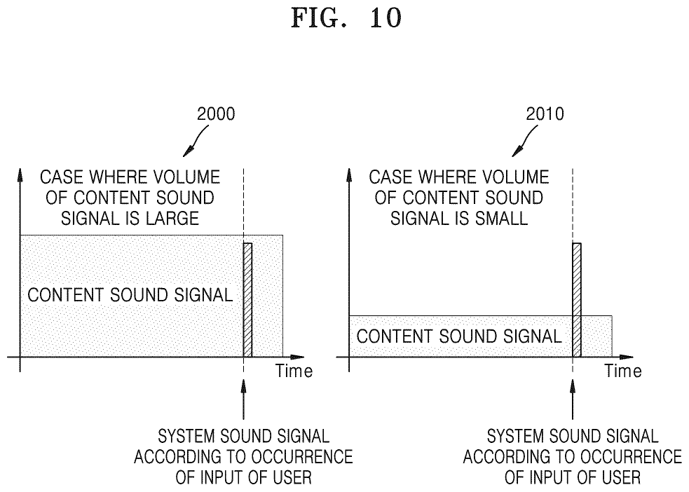

According to an embodiment of the present disclosure, the electronic device 1000 may adjust the volume level of the audio signal output from the electronic device 1000, based on a volume level of a content sound signal 1920 and the information 1910 about the input of the user 1050. For example, an operation of adjusting the volume level of the audio signal output from the electronic device 1000, based on the volume level of the content sound signal 1920 and the information 1910 about the input of the user 1050, will be described in detail with reference to FIGS. 10 to 12.

FIG. 10 is a diagram for describing a method of adjusting a volume of the system sound signal 1930, based on a content sound signal, according to an embodiment of the present disclosure.

According to an embodiment of the present disclosure, the electronic device 1000 may output the system sound signal 1930, according to an input of the user 1050, regardless of a volume of the content sound signal 1920. The volume of the content sound signal 1920 may be relatively great, small, or equal, compared to the volume of the system sound signal 1930 according to the input of the user 1050.

According to an embodiment of the present disclosure, in a case 2000 where the volume of the content sound signal 1920 is relatively large, compared to the volume of the system sound signal 1930, the volume of the system sound signal 1930 according to the input of the user 1050 may be lower than the volume of the content sound signal 1920. Here, the user 1050 cannot clearly hear the volume of the system sound signal 1930 according to the input of the user 1050, and thus, it may be difficult for the user 1050 to recognize whether the input of the user 1050 is correctly received by the electronic device 1000. According to an embodiment of the present disclosure, a case where the volume of the content sound signal 1920 is equal to the volume of the system sound signal 1930 may be included in the case 2000 where the volume of the content sound signal 1920 according to an embodiment of the present disclosure is relatively great, compared to the volume of the system sound signal 1930, but the present disclosure is not limited thereto.

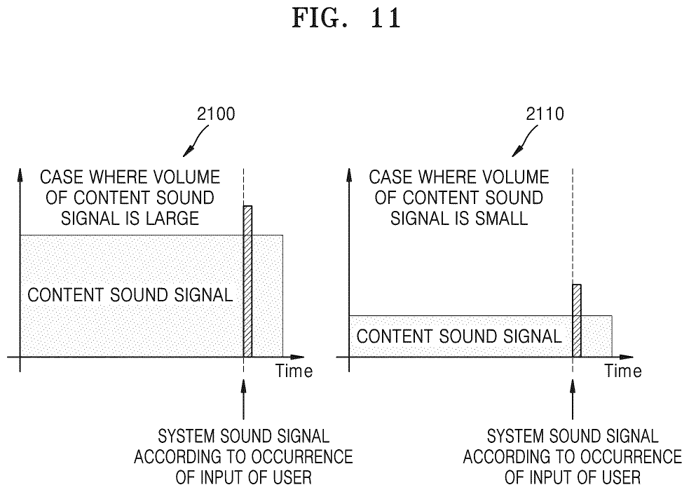

According to an embodiment of the present disclosure, in a case 2010 where the volume of the content sound signal 1920 is relatively small, the volume of the system sound signal 1930 according to the input of the user 1050 may be greater than the volume of the content sound signal 1920. At this time, the user 1050 may quietly watch content, and watching of the content by the user 1050 may be interrupted due to the system sound signal 1930 that is relatively great. Therefore, FIG. 11 shows a method of adjusting a volume of an audio signal output from the electronic device 1000, in consideration of not only the information 1910 about the input of the user 1050 but also a volume of the content sound signal 1920.

FIG. 11 is a diagram for describing a method of adjusting a volume of the system sound signal 1930, based on the content sound signal 1920, according to an embodiment of the present disclosure.

According to an embodiment of the present disclosure, the electronic device 1000 may adjust a volume of an audio signal output from the electronic device 1000, based on a volume of the content sound signal 1920 and information about an input of the user 1050.

According to an embodiment of the present disclosure, when the input of the user 1050 is input one time within a preset time, the electronic device 1000 may adjust a volume of the system sound signal 1930 to be further greater than the volume of the content sound signal 1920. As the electronic device 1000 adjusts the volume of the system sound signal 1930 to be further greater than the volume of the content sound signal 1920, the user 1050 may recognize that the input of the user 1050 is correctly received by the electronic device 1000. The volume of the system sound signal 1930 may not be greater than the volume of the content sound signal 1920 by a preset threshold or more. Thus, even when the system sound signal 1920 is output, the user 1050 may watch content via the electronic device 1000 without great interruption.

For example, in a case 2100 where the volume of the content sound signal 1920 is relatively large, the electronic device 1000 may output the system sound signal 1930 with a volume level being greater than a volume level of the content sound signal 1920 by a preset level. In a case 2100 where the volume of the content sound signal 1920 is relatively small, the electronic device 1000 may output the system sound signal 1930 with a volume level being greater than the volume level of the content sound signal 1920 by a preset level. For example, the electronic device 1000 may output the system sound signal 1930 with a volume level being greater than the volume level of the content sound signal 1920 by 10 dB, but the present disclosure is not limited thereto.

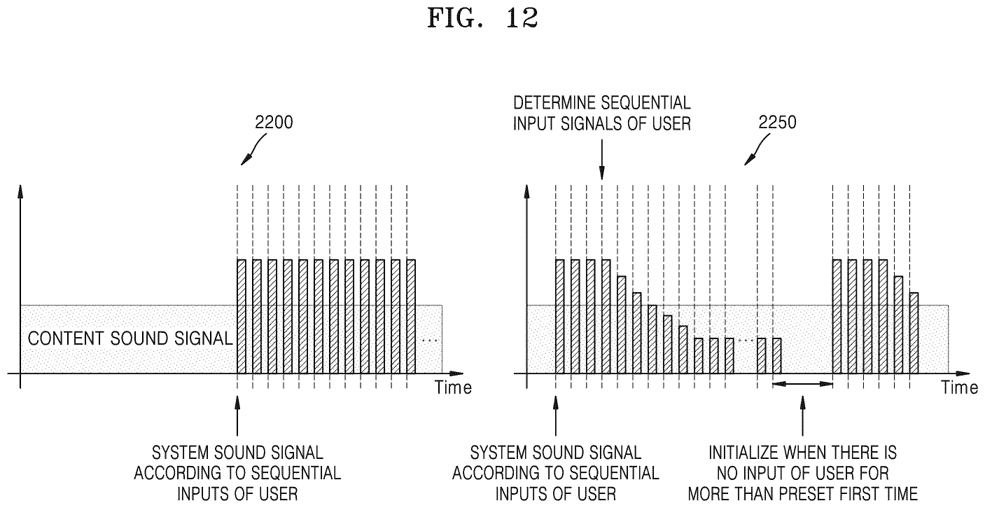

FIG. 12 is a diagram for describing a method of decreasing a volume of the system sound signal 1920 when an input of the user 1050 is input by a preset second threshold or more for a preset first time, according to an embodiment of the present disclosure.

According to an embodiment of the present disclosure, when the input of the user 1050 is input by the preset second threshold or more for the preset first time, the electronic device 1000 may gradually decrease a volume level of the system sound signal 1930, based on the volume of the content sound signal 1920 and information about the input of the user 1050.

According to an embodiment of the present disclosure, when the user 1050 inputs the input of the user 1050 by the preset second threshold or more for the preset first time, the electronic device 1000 may determine that the input of the user 1050 corresponds to sequential inputs of the user 1050 or repetitive inputs of the user 1050. For example, when the user 1050 inputs the input of the user 1050 four times or more for a preset one second, the electronic device 1000 may determine that the input of the user 1050 corresponds to repetitive inputs of the user 1050. When the input of the user 1050 corresponds to repetitive inputs of the user 1050, the processor 1220 of the electronic device 1000 may change a system sound signal corresponding to an input of a user to gradually become lower than a volume of a content sound signal, so that the user 1050 can further comfortably watch content via the electronic device 1000.

According to an embodiment of the present disclosure, the first graph 2200 shows a method by which the electronic device 1000 adjusts the system sound signal 1930, based on the content sound signal 1920 and the information about the input of the user 1050, regardless of whether the input of the user 1050 corresponds to repetitive inputs of the user 1050. As the volume level of the system sound signal 1930 is greater than a volume level of the content sound signal 1920, the user 1050 may easily recognize that the input of the user 1050 is correctly input to the electronic device 1000. Here, in a case where the volume level of the system sound signal 1930 remains greater than the volume level of the content sound signal 1920 even when the user 1050 easily recognizes that the input of the user 1050 is correctly input to the electronic device 1000, the user 1050 may be interrupted in watching of content via the electronic device 1000.

According to an embodiment of the present disclosure, the second graph 2250 shows a method by which the electronic device 1000 adjusts the system sound signal 1930 by overall considering whether the input of the user 1050 corresponds to repetitive inputs of the user 1050, the content sound signal 1920, and the information about the input of the user 1050. For example, when the input of the user 1050 is input by a preset threshold or more within a preset time, the electronic device 1000 may determine that the input of the user 1050 corresponds to sequential inputs of the user 1050. For example, when the input of the user 1050 includes eight inputs per one second, the electronic device 1000 may determine that preset at least four inputs of the user 1050 are input within preset one second, and may determine that the input of the user 1050 corresponds to sequential inputs of the user 1050. Therefore, as shown in the second graph 2250, after the fourth input of the user 1050 is input, the electronic device 1000 may determine that the input of the user 1050 corresponds to sequential inputs of the user 1050.

According to an embodiment of the present disclosure, the electronic device 1000 may gradually decrease a volume level of the system sound signal 1930 which corresponds to an input of the user 1050, the input being input after the electronic device 1000 determines sequential inputs of the user 1050. For example, when the input of the user 1050 is input after the electronic device 1000 determines that the input of the user 1050 corresponds to sequential inputs of the user 1050, the electronic device 1000 may decrease the volume level of the system sound signal 1930 by a preset ratio or preset value. For example, after the fourth input of the user 1050 is input, the electronic device 1000 may determine that the input of the user 1050 corresponds to sequential inputs of the user 1050 Therefore, the system sound signal 1930 that corresponds to a fifth input of the user 1050 after the fourth input of the user 1050 may be output with a gradual decrease. For example, the electronic device 1000 may gradually decrease 5 to 10^{th} inputs of the user 1050 by 10%, but the present disclosure is not limited thereto.

According to an embodiment of the present disclosure, as the electronic device 1000 decreases the volume level of the system sound signal 1930 by a preset ratio or preset value, the volume of the system sound signal 1930 may become smaller than a preset threshold. Compared to the volume level of the content sound signal 1920, the preset threshold may indicate a volume level that does not interrupt the user 1050 in watching content, but the present disclosure is not limited thereto. For example, the preset threshold may indicate a volume level being lower than the volume level of the content sound signal 1920 by a preset level.

According to an embodiment of the present disclosure, with respect to an input of the user 1050 after the volume level of the system sound signal 1930 is decreased by the preset threshold, the electronic device 1000 may not decrease but may maintain the volume level of the system sound signal 1930. For example, the electronic device 1000 may not decrease a volume level of the system sound signal 1930 which corresponds to an input of the user 1050 which is input after the 10th input of the user 1050.

According to an embodiment of the present disclosure, when the electronic device 1000 determines that there is no input of the user 1050 for a preset first time or more, the electronic device 1000 may initialize setting with respect to the volume level of the system sound signal 1930. Also, when the electronic device 1000 receives information about a new input of a user after the electronic device 1000 initialized setting with respect to the volume level of the system sound signal 1930, the electronic device 1000 may output the system sound signal 1930 with the same volume as a volume level of an initial system sound signal, but the present disclosure is not limited thereto. For example, when the volume level of the content sound signal 1920 is changed, the electronic device 1000 may output the system sound signal 1930 with a volume different from the volume level of the initial system sound signal.

FIG. 13 is a flowchart for adjusting a volume of the content sound signal 1920, based on event occurrence information related to occurrence of an event, according to an embodiment of the present disclosure.

In operation S2310, the electronic device 1000 according to an embodiment of the present disclosure may obtain event occurrence information related to occurrence of an event.

According to an embodiment of the present disclosure, the electronic device 1000 may receive, via the communication unit 1260, the event occurrence information related to occurrence of the event from at least one of the external electronic device 1010 or a server. Also, the electronic device 1000 may sense occurrence of the event via the sensing unit 1250 and may obtain the event occurrence information, but the present disclosure is not limited thereto. For example, the electronic device 1000 may receive, via the external device interface unit 1280, the event occurrence information related to occurrence of the event from an external device or the external electronic device 1010.

According to an embodiment of the present disclosure, the electronic device 1000 may store, in the memory 1230, an AI model configured to sense occurrence of an event. For example, the event may include an event related to a guest visiting home, and here, the electronic device 1000 may sense occurrence of the event, based on a doorbell sound. The AI model may be trained with a doorbell sound as training data, and the processor 1220 may determine, by using the AI model, occurrence of an event, based on a doorbell sound due to visiting of a guest.

According to an embodiment of the present disclosure, an event may include an event including at least one of a doorbell, a fire alarm, an important incoming call, and a washing machine alarm. For example, the event may include an event received from a home device related to an Internet of Things (IoT). According to an embodiment of the present disclosure, event occurrence information may include information related to occurrence of an event. For example, in a case where an event of an incoming call from an important customer occurs, the electronic device 1000 may receive information indicating occurrence of the event of an incoming call from an important customer, via the communication unit 1260 from a mobile terminal, but the present disclosure is not limited thereto.

In operation S2320, the electronic device 1000 according to an embodiment of the present disclosure may determine whether the event is included in a preset event, based on the event occurrence information.

According to an embodiment of the present disclosure, the electronic device 1000 may determine whether the event is included in a preset event. For example, the event occurrence information the electronic device 1000 obtained may be information related to occurrence of the event, and may include information indicating what the event is and information whether the event is included in the preset event. Therefore, based on the obtained event occurrence information, the electronic device 1000 may determine whether the event is included in the preset event.

According to an embodiment of the present disclosure, the event may indicate an event that is preset in the memory 1230 of the electronic device 1000, but the present disclosure is not limited thereto. The event being preset in the memory 1230 may be changed and modified, in response to an input received via the user input unit 1270. The preset event being changed and modified, in response to an input received via the user input unit 1270, may be expressed in the form of an event list. For example, the event may include a incoming-call alarm, a message alarm, a washing machine alarm, a doorbell alarm, etc., but the present disclosure is not limited thereto. Also, the event may include an alarm received from the external electronic device 1010 connected to or interoperating with the electronic device 1000, but the present disclosure is not limited thereto.

In operation S2330, the electronic device 1010 according to an embodiment of the present disclosure may determine whether to adjust a volume of the content sound signal 1920, based on determining whether the event is included in the preset event.

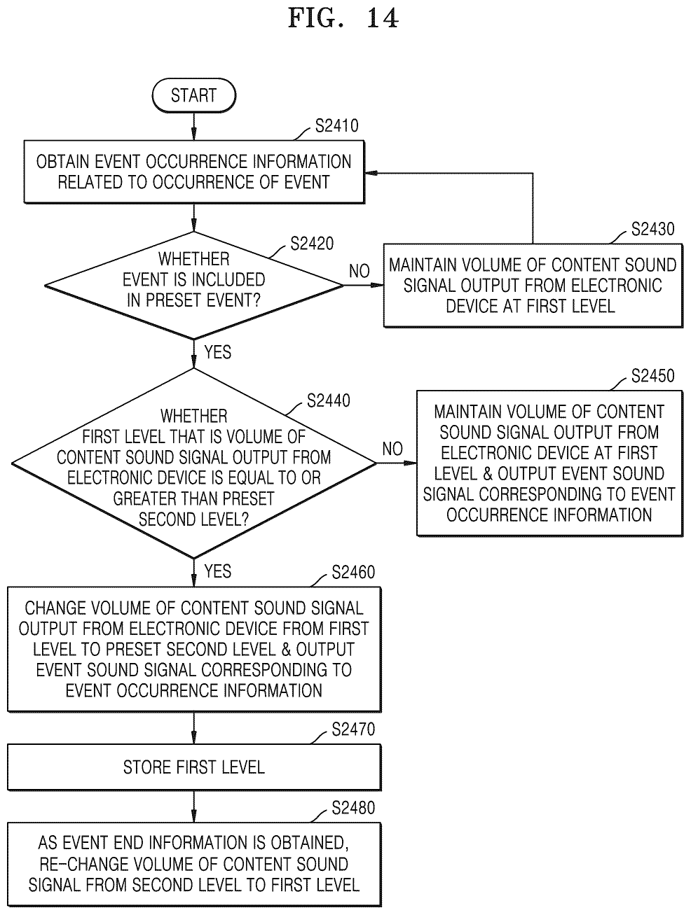

According to an embodiment of the present disclosure, the content sound signal 1920 that is a target of volume adjustment by the electronic device 1000 may include an audio signal related to content output from the audio output unit 1210 of the electronic device 1000, but the present disclosure is not limited thereto. An operation of determining whether to adjust a volume level of the content sound signal 1920 will now be described in detail with reference to FIG. 14.

FIG. 14 is a flowchart for describing a method of adjusting a volume of the content sound signal 1920, based on event occurrence information related to occurrence of an event and event end information related to an end of the event, according to an embodiment of the present disclosure.

In operation S2410, the electronic device 1000 may obtain event occurrence information related to occurrence of an event.

According to an embodiment of the present disclosure, the electronic device 1000 may receive, via the communication unit 1260, the event occurrence information related to occurrence of the event from the external electronic device 1010. Also, the electronic device 1000 may sense the event occurrence information related to occurrence of the event, via the sensing unit 1250. Also, the electronic device 1000 may receive the event occurrence information related to occurrence of the event, from the external electronic device 1010 including an IoT-related home device via the communication unit 1260 or the sensing unit 1250, but the present disclosure is not limited thereto.

In operation S2420, the electronic device 1000 may determine whether the event is included in a preset event.

In operation S2420, the electronic device 1000 according to an embodiment of the present disclosure may determine whether the event is included in the preset event, based on the event occurrence information. In operation S2420, when it is determined that the event is not included in the preset event, it may be more important to make the user 1050 comfortably watch content via the electronic device 1000 rather than notifying the user 1050 of the event. Therefore, in operation S2430, the electronic device 1000 may maintain, without a change, a volume level of the content sound signal 1920, which is output from the audio output unit 1210, at a first level that is an original level.

In operation S2420, when it is determined that the event is included in the preset event, it may be more important to notify the user when the event occurs rather than making the user watch content via the electronic device 1000. Also, before the electronic device 1000 outputs an event sound signal corresponding to the event occurrence information, the electronic device 1000 may determine whether to maintain or decrease a volume of the content sound signal 1920. In operation S2440, the electronic device 1000 may determine whether a first level that is a volume of the content sound signal 1920 output from the electronic device 1000 is equal to or greater than a preset second level.

According to an embodiment of the present disclosure, when the electronic device 1000 determines that the first level that is the volume of the content sound signal 1920 output from the electronic device 1000 is equal to or greater than the preset second level, the electronic device 1000 may determine that a volume level of the content sound signal 1920 is relatively large. In detail, when it is determined that the first level that is the volume of the content sound signal 1920 output from the electronic device 1000 is equal to or greater than the preset second level, in operation S2460, before the electronic device 1000 outputs an event sound signal corresponding to the event occurrence information, the electronic device 1000 may determine to change the volume of the content sound signal 1920 output from the audio output unit 1210 of the electronic device 1000.

According to an embodiment of the present disclosure, when it is determined that the first level that is the volume of the content sound signal 1920 output from the electronic device 1000 is not equal to or greater than the preset second level, the electronic device 1000 may determine that the volume of the content sound signal 1920 is small. In detail, when it is determined that the first level that is the volume of the content sound signal 1920 output from the electronic device 1000 is not equal to or greater than the preset second level, in operation S2450, the electronic device 1000 may output the event sound signal corresponding to the event occurrence information, without a change in the volume of the content sound signal 1920 output from the audio output unit 1210 of the electronic device 1000.

In S2450, the electronic device 1000 may maintain the volume of the content sound signal 1920 output from the electronic device 1000 at the first level, and may output the event sound signal corresponding to the event occurrence information.

According to an embodiment of the present disclosure, when the first level that is the volume of the content sound signal 1920 output from the electronic device 1000 is not equal to or greater than the preset second level, a volume level of the content sound signal 1920 may be sufficiently low. Even when the electronic device 1000 outputs the event sound signal corresponding to the event occurrence information, the user 1050 may easily recognize information of the event sound signal. Therefore, the electronic device 1000 may maintain the volume of the content sound signal 1920 output from the electronic device 1000 at the first level, and may output the event sound signal corresponding to the event occurrence information.

In operation S2460, the electronic device 1000 may change the volume of the content sound signal 1920 output from the electronic device 1000 from the first level to the preset second level, and may output the event sound signal corresponding to the event occurrence information.

In operation S2440, when it is determined that the first level that is the volume of the content sound signal 1920 output from the electronic device 1000 is equal to or greater than the preset second level, it may indicate a state in which the volume level of the content sound signal 1920 is high. Even when the electronic device 1000 outputs the event sound signal corresponding to the event occurrence information, it may be difficult for the user 1050 to easily recognize information of the event sound signal because the content sound signal 1920 overlaps the event sound signal. Therefore, the electronic device 1000 may change the volume of the content sound signal 1920 output from the electronic device 1000 from the first level to the preset second level, and may output the event sound signal corresponding to the event occurrence information. Here, the preset second level may indicate a volume level lower than the first level, but the present disclosure is not limited thereto.

According to an embodiment of the present disclosure, the second level may vary according to content of an event included in the event occurrence information. For example, in a case where the event occurrence information such as a fire alarm, etc. has to be urgently notified to a user, the second level may be preset to be further high. On the contrary, in a case of a not-urgent alarm of the event occurrence information such as an end of washing, the second level may be set to be further low.

In operation S2470, the electronic device 1000 may store the first level that is a volume level of the content sound signal 1920 output from the electronic device 1000.

According to an embodiment of the present disclosure, the electronic device 1000 may sense the first level that is a volume level of the content sound signal 1920 output from the electronic device 1000, and may store it in the memory 1230. In detail, as the electronic device 1000 receives event end information indicating an end of the event, the electronic device 1000 may store the first level that is the volume level of the content sound signal 1920 so as to change the volume level of the content sound signal 1920 from the second level to the first level stored in the memory 1230.

In operation S2480, as the electronic device 1000 obtains the event end information, the electronic device 1000 may re-change the volume of the content sound signal 1920 from the second level to the stored first level.

According to an embodiment of the present disclosure, the event end information may be information indicating an end of the event. For example, the event end information may be information including at least one of information indicating an end of an important call, information indicating extinguishment of fire, and information indicating an end of a doorbell alarm, but the present disclosure is not limited thereto.

According to an embodiment of the present disclosure, the electronic device 1000 may receive or sense the event end information indicating an end of the event, via the communication unit 1260 or the sensing unit 1250. Accordingly, as the electronic device 1000 obtains the event end information, the electronic device 1000 may re-change the volume level of the content sound signal 1920 from the second level to the first level stored in the memory 1260.

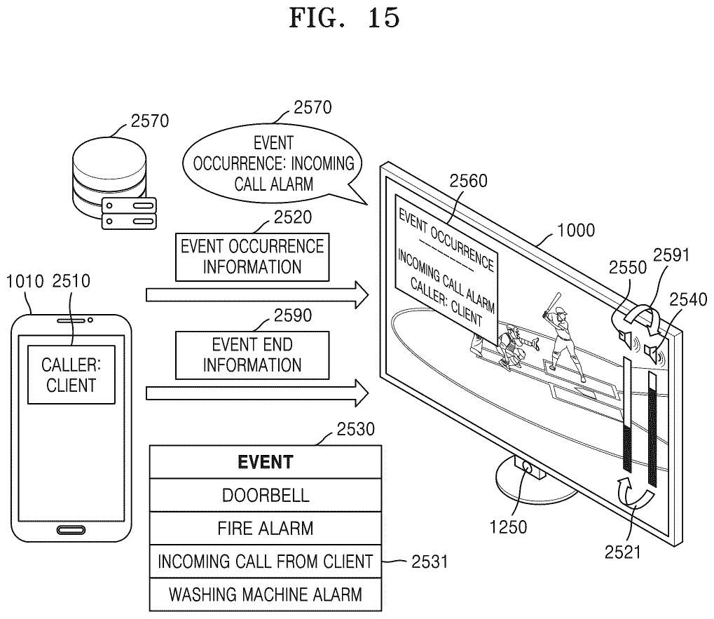

FIG. 15 is a diagram for describing a method of adjusting a volume of a content sound signal, based on event occurrence information related to occurrence of an event and event end information related to an end of the event, according to an embodiment of the present disclosure.

According to an embodiment of the present disclosure, the external electronic device 1010 may receive, from a client, an incoming call alarm 2510. The external electronic device 1050 may be a mobile terminal, but the present disclosure is not limited thereto.

According to an embodiment of the present disclosure, the electronic device 1000 may obtain event occurrence information 2520. For example, the external electronic device 1050 may transmit information about the received incoming call alarm 2510 to the electronic device 1000 via a network 2570 shared with the electronic device 1000. The event occurrence information 2520 in FIG. 15 may include the information about the incoming call alarm 2510. Also, the sensing unit 1250 of the electronic device 1000 may receive a voice signal indicating “incoming call from client” output from the external electronic device 1010, and may obtain event occurrence information related to occurrence of a call event, based on the received voice signal. The sensing unit 1250 may be located at the lower part of the electronic device 1000, but the present disclosure is not limited thereto.

According to an embodiment of the present disclosure, the electronic device 1000 may determine whether the event is included in a preset event, based on the obtained event occurrence information. The preset event may be an event 2530 stored in the memory 1230. For example, when the event 2530 stored in the memory 1230 includes a doorbell, a fire alarm, an incoming call from client 2531, and a washing machine alarm, and the obtained event is the incoming call from client 2510, the electronic device 1000 may determine that the obtained event is an event included in the preset event 2530.

According to an embodiment of the present disclosure, when an event is included in a preset event, the electronic device 1000 may adjust a volume of a content sound signal, in consideration of a volume level of a current content sound signal. For example, in FIG. 15, a first level 2540 that is a volume of content sound may be a volume level equal to or greater than a threshold pre-stored in the memory 1230. In this case, as a volume of the current content sound signal is large, the electronic device 1000 may change the volume of the content sound signal before an output of an event sound signal corresponding to the event occurrence information. In detail, the electronic device 1000 may change (2521) a volume level of the content sound signal from the first level 2540 to a second level 2550.

According to the change (2521) according to an embodiment of the present disclosure, the electronic device 1000 may output, via the audio output unit 1210, an event sound signal indicating “Event occurrence: Incoming call alarm” 2570 corresponding to the event occurrence information. For example, the electronic device 1000 may output the event sound signal indicating “Event occurrence: incoming call alarm” 2570 with a volume level greater than the volume of the content sound signal. Also, the electronic device 1000 may output a UI 2560 including content of “Event occurrence: Incoming call alarm. Caller: client” via the display unit 1240, but the present disclosure is not limited thereto.

According to an embodiment of the present disclosure, the electronic device 1000 may obtain event end information 2590. For example, the event end information 2590 may include information indicating an end of a call from a client. The electronic device 1000 may re-change (2591), based on the event end information 2590, a volume of an audio signal output from the audio output unit 1210 from the second level 2550 to the first level 2540 stored in the memory 1230.

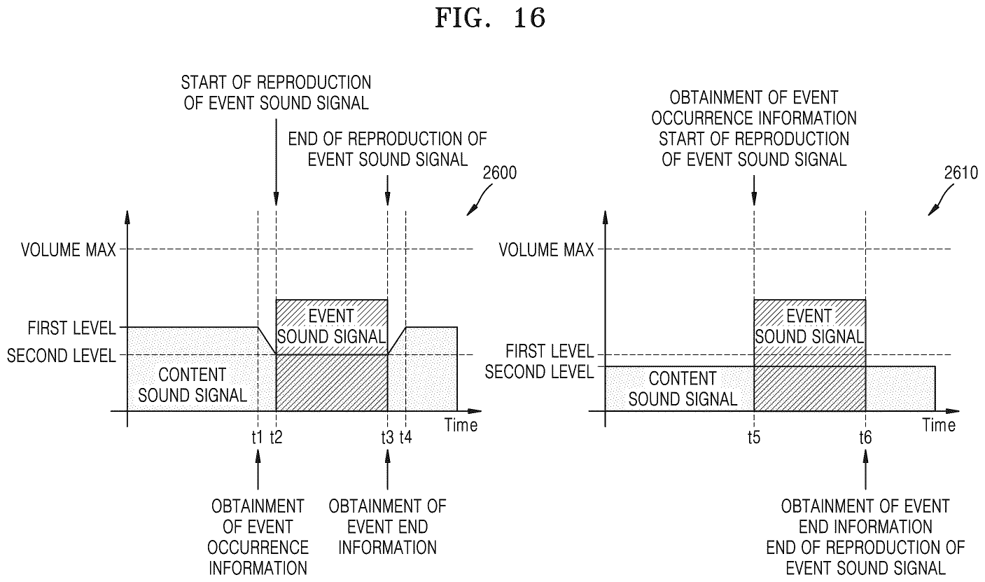

FIG. 16 is a diagram for describing a method of adjusting a volume of a content sound signal, based on event occurrence information related to occurrence of an event and event end information related to an end of the event, according to an embodiment of the present disclosure.

According to an embodiment of the present disclosure, when the event is included in a preset event, the electronic device 1000 may determine whether to adjust the volume of the content sound signal, according to whether a first level that is a volume of an audio signal (which may indicate the content sound signal) output from the electronic device 1000 is equal to or greater than a preset second level.

According to an embodiment of the present disclosure, the graph 1 2600 shows, when a first level that is a volume of a content sound signal output from the electronic device 1000 is equal to or greater than a preset second level, a method of adjusting the volume of the content sound signal and how an event sound signal corresponding to event occurrence information is to be output. When the first level that is the volume of the content sound signal output from the electronic device 1000 is equal to or greater than the preset second level, the electronic device 1000 may adjust a volume level of the content sound signal so as to effectively output an event sound signal without an overlap between audio signals.

According to an embodiment of the present disclosure, the electronic device 1000 may obtain event occurrence information at t1, and a volume of a content sound signal at t1 may be a first level that is equal to or greater than a preset second level. Therefore, before an output of an event sound signal, the electronic device 1000 may change the volume of the content sound signal from a first level to a second level. For example, the volume of the content sound signal at t2 may be the preset second level.

According to an embodiment of the present disclosure, as the volume of the content sound signal is changed to the preset second level, the electronic device 1000 may reproduce an event sound signal corresponding to the event occurrence information. For example, the electronic device 1000 may reproduce the event sound signal from t2 to t3. For example, the electronic device 1000 may output from t2 to t3 the event sound signal indicating “event occurrence: incoming call alarm” 2570 in FIG. 15, but the present disclosure is not limited thereto.

According to an embodiment of the present disclosure, the electronic device 1000 may obtain event end information at a time point of t3 at which reproduction of the event sound signal is ended. For example, when the electronic device 1000 senses, via the sensing unit 1250, that reproduction of the event sound signal is ended, the electronic device 1000 may obtain the event end information after an elapse of a preset time from t3, but the present disclosure is not limited thereto.

According to an embodiment of the present disclosure, after the event end information is obtained at the time point of t3 at which reproduction of the event sound signal is ended, the electronic device 1000 may re-change the volume of the content sound signal from the second level to the first level that is an original volume level. For example, the electronic device 1000 may output the content sound signal with the first level at a time point of t4.

According to an embodiment of the present disclosure, the graph 2 2610 shows, when a first level that is a volume of a content sound signal output from the electronic device 1000 is equal to or less than a preset second level, a method of adjusting the volume of the content sound signal and how an event sound signal corresponding to event occurrence information is to be output. For example, when the first level that is the volume of the content sound signal output from the electronic device 1000 is equal to or less than the preset second level, the electronic device 1000 may not change a volume level of the content sound signal and may output the event sound signal corresponding to the event occurrence information.

According to an embodiment of the present disclosure, the electronic device 1000 may obtain the event occurrence information at a time point of t5. As the first level that is the volume of the content sound signal is equal to or less than the preset second level, the electronic device 1000 may immediately output an event sound signal without a separate operation of adjusting the volume of the content sound signal.

According to an embodiment of the present disclosure, the electronic device 1000 may obtain event occurrence information at a time point of t6. For example, when the electronic device 1000 senses, via the sensing unit 1250, that reproduction of the event sound signal is ended, the electronic device 1000 may obtain event end information after an elapse of a preset time from the time point of t6, but the present disclosure is not limited thereto. Also, as the first level that is the volume of the content sound signal output from the electronic device 1000 is equal to or less than the preset second level, the electronic device 1000 may maintain the volume of the content sound signal at the first level that is an original volume level.

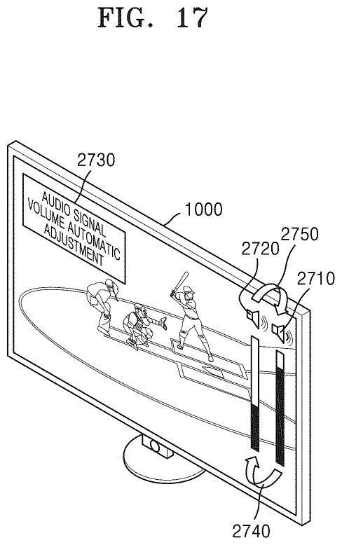

FIG. 17 is a diagram for describing a method of providing a UI related to volume adjustment of an audio signal via the display unit 1240 of the electronic device 1000, according to adjustment of a volume of the audio signal, according to an embodiment of the present disclosure.

According to an embodiment of the present disclosure, according to adjustment of the volume of the audio signal, the electronic device 1000 may provide a UI related to volume adjustment of the audio signal via the display unit 1240 of the electronic device 1000.

According to an embodiment of the present disclosure, the electronic device 1000 may determine whether to adjust a volume of an audio signal output from the electronic device 1000, as information related to volume adjustment of the audio signal is obtained. For example, as the information related to volume adjustment of the audio signal is obtained, the electronic device 1000 may automatically change (2740) a volume of the audio signal output from the audio output unit 1210 from a first level 2710 to a second level 2720 or from the second level 2720 to the first level 2710. Accordingly, the processor 1220 of the electronic device 1000 may control a UI of ‘Audio signal volume automatic adjustment’ 2730 to be output via the display unit 1240, but the present disclosure is not limited thereto. For example, the UI 2560 including content of “Event occurrence: Incoming call alarm. Caller: client” corresponding to the event occurrence information related to an incoming call from a client in FIG. 15 may be output.

According to an embodiment of the present disclosure, as a volume of an audio signal output from the electronic device 1000 may be appropriately adjusted based on information obtained from an external source, the user 1050 may correctly recognize an audio signal output from the electronic device 1000 or the external electronic device 1010.

According to an embodiment of the present disclosure, a method of adjusting a volume of an audio signal output from an electronic device 1000 may include: obtaining, from an external source, information related to volume adjustment of an audio signal output from the electronic device 1000; determining, based on the obtained information, whether to adjust a volume of the audio signal output from the electronic device 1000; and adjusting, based on the determining, the volume of the audio signal output from the electronic device 1000.

According to an embodiment of the present disclosure, the obtained information may include information about an audio signal output from an external electronic device 1010, and the determining of whether to adjust the volume of the audio signal output from the electronic device 1000 may include, when a volume of the audio signal output from the external electronic device 1010 is changed from a first level to a second level by a preset first threshold or more, determining to adjust the volume of the audio signal output from the electronic device 1000.

According to an embodiment of the present disclosure, in the method, the adjusting, based on the determining, of the volume of the audio signal output from the electronic device 1000 may include: changing the volume of the audio signal output from the electronic device 1000 from a first level to a second level; and storing the first level.

According to an embodiment of the present disclosure, the method may further include, when the volume of the audio signal output from the external electronic device 1010 is re-changed from a second level to a first level, re-changing the volume of the audio signal output from the electronic device 1000 from the second level to the stored first level.

According to an embodiment of the present disclosure, the obtaining of the information related to volume adjustment of the audio signal output from the electronic device 1000 may include: receiving an audio signal output from the external electronic device 1010; and determining whether the received audio signal is a signal output from the external electronic device 1010, based on amplitude of each frequency band of the received audio signal.

According to an embodiment of the present disclosure, the obtained information may include information about a user input, and the audio signal may include a content sound signal output from the electronic device (1000) and a system sound signal output from the electronic device (1000).

According to an embodiment of the present disclosure, the determining of whether to adjust the volume of the audio signal output from the electronic device 1000 may include determining to adjust a volume of the system sound signal, based on the content sound signal, as the information about the user input is obtained.

According to an embodiment of the present disclosure, the adjusting of the volume of the system sound signal output from the electronic device 1000 may include adjusting the volume of the system sound signal to correspond to a volume of the content sound signal.

According to an embodiment of the present disclosure, the adjusting of the volume of the system sound signal output from the electronic device 1000 may include decreasing the volume of the system sound signal when the user input is input by a preset second threshold or more for a preset first time.

According to an embodiment of the present disclosure, the obtained information may include event occurrence information related to occurrence of an event, and the audio signal may include a content sound signal output from the electronic device 1000 and an event sound signal output from the electronic device 1000. According to an embodiment of the present disclosure, the determining of whether to adjust the volume of the audio signal may include: determining whether the event is included in a preset event, based on the event occurrence information; and determining whether to adjust a volume of the content sound signal, based on determining whether the event is included in the event.

According to an embodiment of the present disclosure, the obtained information may include event occurrence information related to occurrence of an event. According to an embodiment of the present disclosure, the audio signal may include a content sound signal output from the electronic device 1000 and a system event signal output from the electronic device 1000. According to an embodiment of the present disclosure, the determining of whether to adjust the volume of the audio signal may include: determining whether the event is included in a preset event, based on the event occurrence information; and determining whether to adjust a volume of the content sound signal, based on determining whether the event is included in the event.

According to an embodiment of the present disclosure, the changing of the volume of the content sound signal from the first level to the second level may include: storing the sensed first level in the electronic device 1000; obtaining event end information related to an end of the event; and re-changing the volume of the content sound signal from the second level to the stored first level, based on the event end information being obtained.

According to an embodiment of the present disclosure, the event occurrence information may include at least one of a call reception alarm, a message reception alarm, a doorbell-related alarm or an alarm received from at least one external electronic device.

According to an embodiment of the present disclosure, the method may further include, based on the volume of the audio signal being adjusted, providing a UI related to volume adjustment of the audio signal via the display unit 1240 of the electronic device 1000.

According to an embodiment of the present disclosure, the electronic device 1000 configured to adjust a volume of an audio signal may include: the audio output unit 1210 configured to output the audio signal; the memory 1230 storing one or more instructions; and at least one processor 1220 configured to execute the one or more instructions.

According to an embodiment of the present disclosure, the at least one processor 1220 may be configured to obtain, from an external source, information related to volume adjustment of an audio signal output from the audio output unit 1210, and determine, based on the obtained information, whether to adjust a volume of the audio signal output from the audio output unit 1210, and adjust, based on the determining, the volume of the audio signal output from the audio output unit 1210.

According to an embodiment of the present disclosure, the obtained information may include information about an audio signal output from the external electronic device 1010, the at least one processor 1220 may be configured to, when a volume of the audio signal output from the external electronic device 1010 is changed from a first level to a second level by a preset first threshold or more, adjust the volume of the audio signal output from the audio output unit 1210, the at least one processor 1220 may be configured to determine, based on amplitude of each frequency band of the audio signal output from the external electronic device 1010, whether the received audio signal is a signal output from the external electronic device 1010, and the obtained information may include information about a user input.

According to an embodiment of the present disclosure, the audio signal may include a content sound signal output from the audio output unit 1210 and a system sound signal output from the audio output unit 1210.

According to an embodiment of the present disclosure, the at least one processor 1220 may be configured to determine to adjust a volume of the system sound signal, based on the content sound signal, as the information about the user input is obtained.

According to an embodiment of the present disclosure, the at least one processor 1220 may be configured to decrease the volume of the system sound signal when the user input is input by a preset second threshold or more for a preset first time.

According to an embodiment of the present disclosure, the obtained information may include event occurrence information related to occurrence of an event, and the audio signal may include a content sound signal output from the electronic device 1000 and an event sound signal output from the electronic device 1000.

According to an embodiment of the present disclosure, the at least one processor 1220 may be configured to determine whether the event is included in a preset event, based on the event occurrence information, and determine whether to adjust a volume of the content sound signal, based on determining whether the event is included in the preset event.

A computer-readable recording medium having recorded thereon a program for performing the method according to an embodiment of the present disclosure, on a computer, may be provided. In the present specification, in the method according to an embodiment of the present disclosure, a machine-readable storage medium may be provided in the form of a non-transitory machine-readable storage medium. Here, the term ‘non-transitory storage medium’ may mean that the storage medium is a tangible device and does not include signals (e.g., electromagnetic waves), and may mean that data may be permanently or temporarily stored in the storage medium. For example, the ‘non-transitory storage medium’ may include a buffer in which data is temporarily stored.

According to an embodiment, the method according to various embodiments disclosed in the present specification may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store or directly between two user apparatuses (e.g., smartphones). In a case of online distribution, at least a portion of the computer program product (e.g., a downloadable application) may be at least temporarily stored or temporarily generated in a machine-readable storage medium such as a manufacturer's server, a server of an application store, or a memory of a relay server.

It is obvious to one of ordinary skill in the art that the descriptions of the present disclosure are exemplary and the present disclosure may be easily embodied in many different forms without changing the technical concept or essential features of the present disclosure. Thus, it should be understood that the embodiments described herein should be considered in a descriptive sense only and not for purposes of limitation. For example, configuring elements that are singular forms may be executed in a distributed fashion, and also, configuring elements that are distributed may be combined and then executed.

The scope of the present disclosure is defined by the appended claims, rather than the detailed description, and all differences and modifications that can be derived from the meanings and scope of the claims and other equivalent embodiments therefrom will be construed as being included in the present disclosure.

1. A method of adjusting a volume of an audio signal, the method comprising:
obtaining, from an external source, information related to adjustment of the volume of the audio signal which is output from an electronic device;
determining, based on the obtained information, whether to adjust the volume of the audio signal output from the electronic device; and
adjusting, based on the determining, the volume of the audio signal output from the electronic device.

2. The method of claim 1, wherein the audio signal output from the electronic device is a first audio signal,
the obtained information related to the adjustment of the volume comprises information about a second audio signal that is output from an external electronic device, and
the determining of whether to adjust the volume of the first audio signal output from the electronic device comprises:
based on a volume of the second audio signal output from the external electronic device being changed from a first level to a second level by a preset threshold or more, determining to adjust the volume of the first audio signal output from the electronic device.

3. The method of claim 1, wherein the adjusting, based on the determining, of the volume of the audio signal output from the electronic device comprises:
changing the volume of the audio signal output from the electronic device from a first level to a second level; and
storing information pertaining to the first level.

4. The method of claim 2, further comprising:
based on the volume of the second audio signal output from the external electronic device being re-changed from a second level to a first level, re-changing the volume of the first audio signal output from the electronic device from the second level to the first level based on information that is stored pertaining to the first level.

5. The method of claim 1, wherein the audio signal output from the electronic device is a first audio signal, and the obtaining of the information related to the adjustment of the volume of the first audio signal output from the electronic device comprises:
receiving a second audio signal; and
determining whether the received second audio signal is a signal output from an external electronic device, based on amplitude of each frequency band of the received second audio signal.

6. The method of claim 1, wherein
the obtained information comprises information about a user input, and
the audio signal comprises a content sound signal output from the electronic device and a system sound signal output from the electronic device, and
the determining of whether to adjust the volume of the audio signal output from the electronic device comprises determining to adjust a volume of the system sound signal, based on the content sound signal, as the information about the user input is being obtained.

7. The method of claim 6, wherein the adjusting of the volume of the system sound signal output from the electronic device comprises adjusting the volume of the system sound signal to correspond to a volume of the content sound signal.

8. The method of claim 6, wherein the adjusting of the volume of the system sound signal output from the electronic device comprises decreasing the volume of the system sound signal, based on the user input being input, by a preset threshold or more for a preset time.

9. The method of claim 1, wherein the obtained information comprises event occurrence information related to occurrence of an event,
the audio signal comprises a content sound signal output from the electronic device and an event sound signal output from the electronic device, and
the determining of whether to adjust the volume of the audio signal comprises:
determining whether the event is comprised in a preset event, based on the event occurrence information; and
determining whether to adjust a volume of the content sound signal, based on determining whether the event is comprised in the preset event.

10. The method of claim 2, wherein
the obtained information comprises event occurrence information related to occurrence of an event from the external electronic device,
the second audio signal comprises a content sound signal output from the electronic device and an event sound signal output from the electronic device, and
the determining of whether to adjust the volume of the first audio signal comprises:
determining whether the event is comprised in a preset event, based on the event occurrence information; and
determining whether to adjust a volume of the content sound signal, based on determining whether the event is comprised in the preset event.

11. The method of claim 10, wherein the volume of the content sound signal is changed from a first level to a second level and the changing comprises:
storing information pertaining to the first level in the electronic device;
obtaining event end information related to an end of the event; and
re-changing the volume of the content sound signal from the second level to the stored first level, based on the event end information being obtained, and
the event occurrence information comprises at least one of a call reception alarm, a message reception alarm, a doorbell-related alarm or an alarm received from the external electronic device.

12. The method of claim 1, further comprising, based on the volume of the audio signal being adjusted, providing a user interface (UI) related to volume adjustment of the audio signal via a display of the electronic device.

13. An electronic device , comprising:
an audio output configured to output an audio signal;
a memory to store one or more instructions; and
at least one processor configured to execute the one or more instructions to:
obtain, from an external source, information related to adjustment of a volume of the audio signal output from the audio output, and
determine, based on the obtained information, whether to adjust the volume of the audio signal output from the audio output, and adjust, based on the determining, the volume of the audio signal output from the audio output.

14. The electronic device of claim 13, wherein the audio signal output from the audio output is a first audio signal,
the obtained information comprises information about a second audio signal output from an external electronic device, and
the at least one processor is configured to:
based on a volume of the second audio signal output from the external electronic device being changed from a first level to a second level by a preset threshold or more, adjust the volume of the first audio signal output from the audio output,
determine, based on amplitude of each frequency band of the second audio signal output from the external electronic device, whether the second audio signal is a signal output from the external electronic device,
the obtained information comprises information about a user input,
the audio signal comprises a content sound signal output from the electronic device and a system sound signal output from the electronic device, and
the at least one processor is configured to determine to adjust a volume of the system sound signal, based on the content sound signal, as the information about the user input is obtained.

15. A non-transitory computer-readable recording medium having recorded thereon a program executable on a computer to perform the method of claim 1.
